(19) United States
(12) Patent Application Publication
(10) Pub. No.: US 2007/0125700 A1
(43) Pub. Date: Jun. 7, 2007

(54) Nanoweb composite material and gelling method for preparing same

(76) Inventors: Jiang Ding, Wilmington, DE (US); Yu-Ling Hsiao, Villanova, PA (US); Christian Peter Lenges, Wilmington, DE (US); Yanhui Niu, Newark, DE (US); Stefan Reinartz, Wilmington, DE (US); Cheryl Marie Stancik, Wilmington, DE (US); Judith Johanna Van Gorp, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/294,009

(22) Filed: Dec. 5, 2005

(51) Int. Cl. B01D 29/46

(52) U.S. Cl. 210/490; 210/505; 55/527; 428/221; 264/45.1

(57) ABSTRACT

The invention discloses novel composite materials comprising a porous support and a nanoweb coating and/or interpenetrating the porous support. The nanoweb is comprised of fibrous structures derived from gelation and drying of supramolecular assemblies of non-covalently bonded organogelators. Typical organogelators useful in the invention include those that assemble via hydrogen bonding and π-stacking. Methods for preparing the composite materials are also disclosed that include critical point drying of the gelled nanowebs with carbon dioxide. The composites are useful as filters for gaseous and liquid fluids, as barrier fabrics, and as cleaning wipes.

### BACKGROUND OF INVENTION

1. Field of Invention

The present invention relates to composite materials for use as separation media in filters for gases and liquids, as barrier fabrics, and as cleaning wipes.

2. Background of Invention

The substantial removal of some or all of a particulate material from a fluid stream, e.g. gas or aqueous stream, can be important for many reasons including safety and health, machine operation and aesthetics. Filter media materials are used in filtration structures placed in the fluid path to obtain physical separation of the particulate from the fluid flow. Filter media are desirably mechanically stable, have good fluid permeability, relatively small pore size, low pressure drop and resistance to the effects of the fluid such that they can effectively remove the particulate from the fluid over a period of time without serious mechanical media failure. Filter media can be made from a number of materials in woven, non-woven or film material forms. Such materials can be air laid, wet laid, melt blown, or otherwise formed into a sheet-like material with an effective pore size, porosity, solidity or other filtration requirements.

Material and non-woven filter elements can be used as surface loading media. In general, such elements comprise porous films or dense mats of cellulose, cellulose derivatives, glass, PTFE, synthetic polymers and fibers oriented across a stream carrying particulate material. The media is generally constructed to be permeable to the fluid flow, and to also have a sufficiently fine pore size and appropriate porosity to inhibit the passage of particles greater than a selected size therethrough. As materials pass through the media, the upstream side of the media operates through diffusion and interception to capture and retain selected sized particles from the fluid (gas or liquid) stream. The particles are collected as a dust cake on the upstream side of the filter media, in the case of a gas stream, for instance. In time, the dust cake also begins to operate as a filter, increasing efficiency. This is sometimes referred to as “seasoning,” i.e. development of an efficiency greater than initial efficiency. PTFE materials and similar microporous materials primarily operate as surface loading or barrier filters.

Dense woven and nonwoven fabrics can operate as a combination of surface loading media and depth media, wherein the particles are trapped throughout the depth of the media. The pore size of the fabrics is dependent upon the size and density of the fibers and the process by which they are formed. The efficiency of the filter media is dependent upon many parameters including the depth of the filter media, pore size, and electrostatic nature of the material. However, it is often desirable to fine-tune the pore properties of depth media as exemplified in the following patents and patent applications.

Carlson, et al., in U.S. Pat. No. 4,629,652, discloses a process for providing a palletized aerogel comprising a support structure to a silicon-based pre-gel heated to supercritical conditions. Upon venting the fluid phase under supercritical conditions, the aerogel forms on and/or within the support structure. This method of solvent removal avoids the inherent shrinkage of the solid product that occurs when conventional drying techniques are employed. Martin, in U.S. Pat. No. 5,156,895, discloses a body including a support structure in which is formed monolithic aerogel. One aspect of the method of making the body includes a solvent substitution step and a supercritical drying step. In both of these cases, the aerogel is a covalently bonded cross-linked network.

Gels can be created in traditional organic solvents through non-covalent interactions such as hydrogen bonding, association between ionic groups, or association between electron-donating and electron-accepting moieties, of self-assembling, low molecular weight compounds. To form foams or materials from such gels, it is necessary to preserve the supramolecular aggregates created in solution, both during and after solvent removal. Although molecules that aggregate in solution are well known, for example via multipoint hydrogen bonding, only rarely do the aggregates form structures that can be preserved after removal of the solvent.

Weiss, et al., in U.S. Pat. No. 5,892,116, describes the gelation of various monomers with subsequent polymerization of the gelled monomers to form organic zeolites and material materials. The gelator is removed from the cross-linked matrix by treatment with a solubilizing solvent to provide a porous cross-linked matrix.

Woven and nonwoven fabrics are also used extensively in the protective apparel and building products markets. A key characteristic of barrier products is the ability to allow passage of air, while inhibiting the passage of particles, water and other liquids. WO 2004/027140 entitled “Extremely High Liquid Barrier Fabrics,” for instance, discloses many aspects of barrier fabrics.

In US 2004/0213918, Mikhael, et al., discloses a coating process that allows modification of the surface properties of a porous substrate without changing significantly the air permeability. This process is described as being accomplished by controlling the coating of individual fibers in ultra-thin layers that do not extend across the pores in the material.

### SUMMARY OF INVENTION

One embodiment of the invention is a method for making a composite material comprising a porous support and a porous nanoweb comprising the steps of: (a) providing a porous support; (b) providing a gelling mixture comprising one or more solvents and one or more organogelator(s); (c) applying the gelling mixture to the porous support; (d) inducing said organogelator(s) to form a nanoweb gel; and (e) removing the solvent(s) from the nanoweb gel to provide a dry porous nanoweb coating on said porous support.

Another embodiment of the invention is a composite material comprising a porous support and a porous nanoweb, wherein said porous nanoweb comprises fibrous structures of between about 10 nm and about 1000 nm effective average fiber diameter as determined with electron microscopy; said fibrous structures being comprised of one or more non-covalently-bonded organogelators.

The composite materials of the invention are useful as separation devices, for instance, as filters for gaseous and liquid fluids; as barrier fabrics; and as conformable cleaning wipes; and further embodiments of the invention include these articles.

### DESCRIPTION OF THE DRAWINGS

FIG. 1 illustrates the dual beam scanning electron microscopy (DB-SEM) images at (a) 25000× and (b) 50000× magnification showing the nanoweb of (V) on and within the porous support.

FIG. 2 illustrates the DB-SEM micrograph at 5000× magnification showing the nanoweb of (V) on the porous support.

FIG. 3 illustrates the DB-SEM micrograph at 10000× magnification showing the nanoweb of (V) prepared from vacuum oven drying on the porous support.

FIG. 4 illustrates the DB-SEM micrograph at (a) 15000× and (b) 35000× magnification showing the nanoweb of (V) within the porous support.

FIG. 5 illustrates the DB-SEM micrograph at 10000× magnification showing the nanoweb of (V) on the porous support.

FIG. 6 illustrates the DB-SEM micrograph at a magnification of 10000× showing the nanoweb fibers intact within the porous support as viewed from (a) the material surface exposed to the air pressure (top) and (b) the opposite material surface (bottom).

FIG. 7 illustrates the DB-SEM micrograph at 5000× magnification showing the nanoweb fibers of (XLIII) on a nonwoven polyethylene porous support.

FIG. 8 illustrates the DB-SEM micrograph at 5000× magnification showing the nanoweb fibers of π-stacked organogelator (LII) on a nonwoven polyethylene porous support.

FIG. 9 illustrates (a) advancing water contact angle of 157° and (b) receding water contact angle of 130° for a nanoweb coating of the invention.

FIG. 10 illustrates the DB SEM micrograph (5,000×) showing a nanoweb coating on a porous support according to the invention.

### DETAILED DESCRIPTION OF THE INVENTION

The applicants have found that conventional porous supports used as filter media and other barrier fabrics can be modified by coating of a gelling mixture containing an organogelator onto, and optionally infusion into a porous support, followed by gelling the organogelator to form a nanoweb gel. Removal of the solvent can give a dry porous nanoweb coating that may interpenetrate the original porous support. The resulting composite material exhibits significantly modified pore properties over that of the original porous support. The applicants have found that a wide variety of gelling materials and porous supports can give useful nanoweb composite materials. The process provides coatings that are characterized by fibrous structures that generally overlay and bridge individual fibers and pores of porous supports. Applicants have found the coated products can have very high water contact angles and high hydrocarbon repellency relative to that of uncoated porous supports.

In another embodiment, the product of the invention is unique in that a porous interpenetrating nanoweb is provided by the non-covalent bonding in a supramolecular assembly of molecules providing a composite material with useful properties.

In another embodiment, the inventive nanowebs not only coat, but also interpenetrate the porous support to form three dimensional nanowebs on and within the porous support.

In another embodiment, depending on the pore sizes in the support, the inventive nanowebs do not bridge the pores, but instead act to coat the support fibers themselves.

Supports

Porous supports useful in the invention include those characterized by an average mean flow pore diameter of about 10 nm and greater, and more preferably 100 nm to 100 micron, as determined by the well known technique of capillary flow porometry described by Mayer in “Porometry measurement of air filtration media,” (American Filtration Separations Society 2002, Topical Conference (2002, Nov. 14-15) Cincinnati, Ohio). Similar methods for characterization of liquid microporous membranes are defined in U.S. Pat. No. 6,413,070, and references cited therein, herein incorporated by reference.

Porous supports useful in the invention include woven and nonwoven fabrics, sheet materials and films, monolithic aggregates, powders, and porous articles such as frits and cartridges. Porous supports include: woven fabrics comprising glass, polyamides including but not limited to polyamide-6,6 (PA-66), polyamide-6 (PA-6), and polyamide-6,10 (PA-610), polyesters including but not limited to polyethylene terephthalate (PET), polytrimethylene terephthalate, and polybutylene terephthalate (PBT), rayon, cotton, wool, silk and combinations thereof; nonwoven materials having fibers of glass, paper, cellulose acetate and nitrate, polyamides, polyesters, polyolefins including bonded polyethylene (PE) and polypropylene (PP), and combinations thereof. Porous supports include nonwovens fabrics, for instance, polyolefins including PE and PP such as TYVEK® (flash spun PE fiber), SONTARA® (nonwoven polyester), and XAVAN® (nonwoven PP), SUPREL®, a nonwoven spunbond-meltblown-spunbond (SMS) composite sheet comprising multiple layers of sheath-core bicomponent melt spun fibers and side-by-side bicomponent meltblown fibers, such as described in U.S. Pat. No. 6,548,431, U.S. Pat. No. 6,797,655 and U.S. Pat. No. 6,831,025, herein incorporated by reference all trademarked products of E.I. du Pont de Nemours and Company; nonwoven composite sheet comprising sheath-core bicomponent melt spun fibers, such as described in U.S. Pat. No. 5,885,909, herein incorporated by reference; other multi-layer SMS nonwovens that are known in the art, such as PP spunbond-PP meltblown-PP spunbond laminates; nonwoven glass fiber media that are well known in the art and as described in Waggoner, U.S. Pat. No. 3,338,825, Bodendorf, U.S. Pat. No. 3,253,978, and references cited therein, hereby incorporated by reference; and KOLON® (spunbond polyester) a trademarked product of Korea Vilene. The nonwovens materials include those formed by web forming processing including dry laid (carded or air laid), wet laid, spunbonded and melt blown. The nonwoven web can be bonded with a resin, thermally bonded, solvent bonded, needle punched, spun-laced, or stitch-bonded. The bicomponent melt spun fibers, referred to above, can have a sheath of PE and a core of polyester. If a composite sheet comprising multiple layers is used, the bicomponent melt-blown fibers can have a PE component and a polyester component and be arranged side-by-side along the length thereof. Typically, the side-by-side and the sheath/core bicomponent fibers are separate layers in the multiple layer arrangement.

Preferred nonwoven porous supports include woven fabrics comprising glass, polyamides, polyesters, and combinations thereof; and nonwoven fabrics comprising glass, paper, cellulose acetate and nitrate, polyamides, polyesters, polyolefins, and combinations thereof. Most preferred porous supports include nonwoven bonded PE, PP, and polyester, and combinations thereof.

Other preferred nonwoven porous supports include electrospun nanofiber supports such as described by Schaefer, et al., in US 2004/0038014, hereby incorporated by reference; and electro-blown nanofiber supports disclosed in Kim, WO 2003/080905, hereby incorporated by reference. The nanofiber supports can be self-supporting or can be supported by other porous support layers. Preferably, the electropsun fiber supports are nanofiber supports comprised of nanofibers with an effective fiber diameter in the range of about 20 nm to about 1 μm, and preferably about 100 nm to about 750 nm. Nanofiber supports useful in the invention include those derived from electro-spinning of polyester, polyamide, cellulose acetate, polyvinylidene fluoride (PVdF), polyacrylonitrile (PAN), polysulfone, polystyrene (PS), and polyvinyl alcohol (PVA). A preferred nanofiber porous support is incorporated into a layered structure comprising one or more other porous supports or scrims, for instance, nonwoven bonded PE or PP, and one or more layers of nanofiber, such as described in U.S. patent application Ser. No. 10/983,513 filed in November 2004, hereby incorporated by reference.

Other porous supports include microporous polymer films and sheet materials such as polyethersulfone, hydrophilic polyethersulfone, polyamide, PP, polytetrafluoroethylene (PTFE), and cellulose esters including cellulose acetate and nitrate. Microporous polymer films include stretched PTFE materials such as those manufactured by W. L. Gore and Associates, Inc. under the trade name GORE-TEX®, and the PTFE material trade named TETRATEX®, manufactured by the Donaldson Company; PP membranes; hydrophilic PP membranes, nitrocellulose membranes such as BIOTRACE™ NT, modified nylon membranes such as BIO-INERT®, PVdF membranes such as BIOTRACE™ PVDF, polyethersulfone membranes such as OMEGA™, SUPOR® hydrophilic polyethersulfone membrane, ion exchange membranes such as MUSTANG™, all brand names of Pall Life Sciences; nylon membranes disclosed in U.S. Pat. No. 6,413,070 and references cited therein, herein incorporated by reference. Preferred microporous polymer films are polyethersulfone, hydrophilic polyethersulfone, polyamide, PP, PTFE, and cellulose esters.

Further porous supports include inorganic materials comprising clay, graphite, talc, glass, sintered metals and ceramics; and wood and wood laminates. The above list of porous supports while extensive is not meant to be exhaustive; other supports may be likewise used in the structures detailed in the examples as one skilled in the art may readily accomplish.

In some instances, it may be advantageous to coat nonporous supports with the nanowebs of the present invention. Nonporous supports useful in the invention include nonporous glass, ceramic, metal, thermoplastic and thermoset polymers, and composites thereof.

Porous Nanoweb

By “porous nanoweb” we mean a non-covalently-bonded supramolecular assembly of molecules that has the morphology of a web. The nanoweb is comprised of self-assembled fibrous structures, including fibers, strands and/or tapes, of sufficient geometry and length to interact with one another through junctions to form network structures. Preferably the fibrous structures are between about 10 nm and about 1000 nm effective average fiber diameter as determined with electron microscopy, either transmission electron microscopy (TEM) or SEM. The term “effective fiber diameter” is defined as the mean diameter of about 15-20 fibers in a given SEM or TEM image. The nanoweb fibrous structures may be crystalline, liquid crystalline, amorphous or a mixture of phases; and are comprised of one or more organogelators. Preferably, the nanoweb is comprised of one or more H-bonded organogelators or π-stacked organogelators, defined further below. In one embodiment the nanoweb is substantially crystalline and may exhibit a melting point. Preferred nanowebs comprise organogelators with melting points of between about 100° C. and about 300° C., and more preferably, between about 100° C. and about 220° C.

The nanoweb fibrous structures coat the surface of the porous support and can also be present within the porous support.

Throughout the specification discussion of characterizations of the “nanoweb” means the characterizations of the composite material comprising the nanoweb and porous support, unless specifically stated otherwise. In many instances, comparisons of properties are made between the composite material and the porous support without the nanoweb.

Characterizations

The porous nanoweb is characterized by a pore size distribution with pore diameters less than that of the porous support and a bubble point pressure that is greater than that of the porous support. The bubble point pressure and pore diameters of the nanoweb are characterized by capillary flow porometry (see Example 9) which is a valuable and well known characterization technique used in industry and described by Mayer (“Porometry measurement of air filtration media” American Filtration Separations Society 2002: Topical Conference (2002, Nov 14-15) Cincinnati, Ohio).

In capillary flow porometry, a wetting liquid of known surface tension (γ) is permitted to wet the sample. This process is spontaneous. A pressure of non-reacting gas is then applied to the sample to cause the wetting liquid to become displaced from the pores of the sample. During this process, both the pressure of the gas and flow of wetting liquid from the sample are accurately measured. The differential pressure of gas (P) required to remove the liquid from the pores is inversely related to the pore diameter (D) and can be approximated as

$$D = \frac{4 γ cos θ}{P}$$

where θ is the contact angle of the liquid. From the pressure and flow rate data, the pore properties can be calculated, including the bubble point pressure (which is the pressure when the largest pore is evacuated of liquid), largest pore diameter, mean flow pore diameter, and smallest pore diameter.

The nanoweb can have a smallest pore diameter about 30% less than that of the porous support, and even about 50% less than that of the porous support. The nanoweb can have a mean flow pore diameter about 50% less than that of the porous support, and even about 75% less than that of the porous support. The nanoweb can have a largest pore diameter about 70% less than that of the porous support, and even about 95% less than that of the porous support. The nanoweb can have a bubble point pressure about 50% greater than that of the porous support, and even about 100% greater than that of the porous support.

The porous nanoweb can be further characterized by specific surface area (SSA) determined using the BET method as defined by Brunauer, et al. (J. Am. Chem. Soc. (1938) 60, 309). The nanoweb can have an SSA of at least about 50% greater than that of the porous support, and even greater than about 100% that of the porous support. Typically, the nanoweb composite materials exhibit a two-fold to 100-fold increase in SSA over that of the porous support. Preferred composite materials of the invention exhibit a percent increase in BET SSA relative to their unmodified porous supports of greater than about 100%, and even greater than about 1000%.

The porous nanoweb coatings of the invention can be further characterized by a quantitative estimation of the surface tension relative to that of the support. Surface tension is typically characterized by measuring the contact angle of a water droplet or other liquid substance, contacting the surface in the advancing and receding dynamic modes. Contact angles can also be measured in a static mode. This is a well known method for determining surface properties and is discussed in detail in Physical Chemistry of Surfaces, 4th Ed., Arthur W. Adamson, John Wiley & Sons, 1982, pp. 338-361. The water contact angle is a quantitative measurement of the hydrophobicity of a surface. The higher the hydrophobicity, the higher will be the contact angle of the water droplet. Surfaces exhibiting water droplet advancing contact angles of greater than 150° are considered super-hydrophobic. The details of contact angle measurements are discussed in the examples. Preferred nanoweb coatings of the invention are characterized by water droplet advancing contact angle of greater than 130°. Other preferred coatings of the invention are characterized by a static hexadecane droplet contact angle of about 70° or greater, indicating oleophobicity.

Additionally, the porous nanoweb coatings can be characterized by the isopropyl alcohol (IPA) repellency test, designed to measure the resistance of nonwoven fabrics to penetration by low surface tension liquids, such as alcohol/water solutions. In the test, a material's resistance to penetration by low surface energy fluids is determined by placing 0.1 mL of a specified volume percentage of isopropyl alcohol (IPA) solution in several different locations on the surface of the material and leaving the specimen undisturbed for 5 minutes. In this test, 0.1 mL of serially diluted IPA and distilled water solutions, ranging from 0 vol. % to 100 vol. % in increments of 10 vol. %, are placed on a fabric material arranged on a flat surface. After 5 minutes, the fluid droplet is soaked up, the sample is visually inspected and the highest concentration of retained by the fabric substrate is noted. For example, if the maximum value retained is a 70 vol. % IPA solution, i. e. an 80 vol. % solution penetrates through the fabric to the underlying surface, the rating is a “7”, if the maximum value retained is 100 vol. % IPA, the rating is a “10”. Preferred nanoweb coatings of the invention are characterized by an IPA repellency test rating of 7 or greater.

The porous nanoweb coatings can be further characterized by the oil repellency test, designed to measure the resistance of nonwoven fabrics to penetration by increasingly hydrophobic hydrocarbon solvents. Six different hydrocarbon solvents are used in this test (in the order from highest surface tension to lowest): 1) Kaydol, 2) 65/35 Kaydol/n-Hexadecane, 3) n-Hexadecane, 4) Tetradecane, 5) n-Dodecane, 6) n-Decane. Beginning with the lowest numbered test liquid, a drop of liquid is carefully placed in several locations of the surface. This is repeated with higher numbered liquids until the highest numbered liquid is reached that does not wet the surface in 30 sec as indicated by visual inspection after soaking up the drop. Since six solvents are used in this test, the highest rating is “6”. Preferred nanoweb coatings of the invention are characterized by an oil repellency test rating of 4 or greater.

Organogelators

The composition of the invention comprises at least one organogelator. An organogelator is defined herein to include a non-polymeric organic compound whose molecules can establish, between themselves, at least one physical interaction leading to a self-assembly of the molecules in a carrier fluid, with formation of a 3-D network, or a “nanoweb gel”, that is responsible for gelation of the carrier fluid. The nanoweb gel may result from the formation of a network of fibrous structures due to the stacking or aggregation of organogelator molecules. Depending on the nature of the organogelator, the fibrous structures have variable dimensions that may range up to one micron, or even several microns. These fibrous structures include fibers, strands and/or tapes.

The term “gelling” or “gelation” means a thickening of the medium that may result in a gelatinous consistency and even in a solid, rigid consistency that does not flow under its own weight. The ability to form this network of fibrous structures, and thus the gelation, depends on the nature (or chemical structure) of the organogelator, the nature of the substituents, the nature of the carrier fluid, and the particular temperature, pressure, concentration, pH, shear conditions and other parameters that may be used to induce gelation of the medium. The nanoweb gels used in the invention can be reversible. For instance, gels formed in a cooling cycle may be dissipated in a heating cycle. This cycle of gel formation can be repeated a number of times since the gel is formed by physical, non-covalent interactions between gelator molecules, such as hydrogen bonding.

The composition of the invention can be made using a nanoweb gel that comprises a nanoweb phase and a fluid phase, which, upon removal of the fluid, forms a porous interpenetrating nanoweb. The applicants have found that this capability is strongly dependent upon the particular structural characteristics of the organogelator and particular processing parameters including the nature of the solvent, temperature, gelator concentration, method of solvent removal, and the nature of the porous support.

The physical interactions of the organogelators are diverse and may include interactions chosen from hydrogen-bonding interactions, π-interactions between unsaturated rings, dipolar and van der Waals interactions, and coordination bonding with organometallic derivatives. In general, the non-covalent forces are weak compared to covalent bonds, which makes them reversible, and it requires that several of them be combined to form a strong association. For example, as discussed in Goshe, et al. (Proc. Nat. Acad. Sci. USA (2002) 99, 4823), the energy of a covalent C—C bond is 350 kJ/mol, while the energy of a hydrogen bond ranges from 4 to 120 kJ/mol, and that of a π-stack from 4 to 20 kJ/mol. The establishment of these interactions may often be promoted by the architecture of the molecule, such as by one or more heteroatom-hydrogen bonds, aromatic rings, unsaturation, bidentate metal coordination sites, and favorable packing geometries. In general, each molecule of an organogelator can establish several types of physical interaction with a neighboring molecule. Thus, in one embodiment, the organogelator according to the invention preferably comprises at least one conjugated group capable of establishing at least two hydrogen bonds; at least one group having at least two aromatic rings in conjugation; at least one group having 14-atom aromatic system; or at least one group capable of bidentate coordination with a metal ion. The organogelators useful in the invention include those selected from the group: H-bonded organogelators, π-stacked organogelators, van der Waals-complexed, and metal coordinated organogelators; and preferably, are further characterized by a molecular weight of about 200 to about 5000 g/mol; and more preferably, by a molecular weight of about 200 to about 2000 g/mol.

H-Bonded Organogelators

The H-bonded organogelators useful in the invention include those characterized by at least two N—H bonds per molecule wherein the nitrogens are bound to at least one carbonyl group, and preferably, they have at least four N—H bonds per molecule. Preferred are organogelators having two or more groups per molecule selected from the group of: urea, ureido-pyrimidone, ureido-triazine, amide, urethane, and a mixture thereof. Thus, bis urea compounds, bis urethane compounds, bis amide compounds, bis ureido-pyrimidones, urea amides, urea urethanes, urea ureido-pyrimidones, and the like are useful in the invention. Organogelators comprised of one or more urea groups are especially preferred.

H-bonded organogelators useful in the invention, methods of preparation and methods for gelling specific organogelators are well know in the art. In addition to the references cited above in the background, Ferrari in US 2004/0223987, hereby incorporated by reference, discloses on pages 11 thru 15, diamides, diurethanes, diureas and urethane-ureas useful as gelators. Breton, et al., in U.S. Pat. No. 6,872,243, hereby incorporated by reference, discloses classes of bis-ureas, ureidopyrimidones and bis-ureidopyrimidones useful as organogelators. Sijbesma, et al., in U.S. Pat. No. 6,320,018, hereby incorporated by reference, discloses further bis-ureidopyrimidones and synthetic methods for preparation of the same.

Preferred H-bonded organogelators include those of formulae (I), (IIA), (IIB), (IIC) and (IID) including isomers or mixtures of isomers thereof: 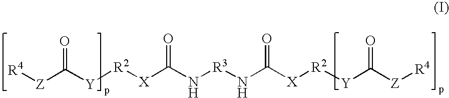
wherein
p is 0, 1, 2, or 3;
   wherein
R³ is a divalent C3 to C18 linear or branched alkylene group, optionally, interrupted by one or two —OC(O)— groups; C1 to C6 linear or branched alkylene group bearing a C5-C16 cycloaliphatic group; C5-C16 cycloaliphatic or alkyl substituted cycloaliphatic group; C6 to C16 aromatic or alkyl substituted aromatic group; or C1 to C6 alkyl bearing an C6 to C16 aromatic or alkyl substituted aromatic group, optionally substituted on the aromatic group with Cl, Br, I, F, CF₃, CF₃O; a —(CH₂CH₂O)ₘ(CH₂CH₂)— group with m being 1 to 4; and
R⁴ independently is a monovalent C2 to C16 linear or branched alkyl group; C5 to C12 cycloaliphatic group; C6 to C16 cycloaliphatic group bearing a linear or branched C1 to C8 alkyl group; C6 to C16 aromatic or alkyl substituted aromatic group; C1 to C6 alkyl bearing an C6 to C16 aromatic or alkyl substituted aromatic group; —(CH₂CH₂O)ₙCH₃ group with n being independently 1 to 8; all aromatic groups optionally substituted with Cl, Br, I, F, CF₃, CF₃O and all alkyl and cycloaliphatic groups optionally substituted with one or two carbon-carbon double bonds;
   wherein
if p is 0, R² is a monovalent C1 to C16 linear or branched alkyl group, a C1 to C6 linear or branched alkyl group bearing a C5-C16 cycloaliphatic group, a C5-C16 cycloaliphatic or alkyl substituted cycloaliphatic group, a C6 to C16 aromatic or alkyl substituted aromatic group, a C1 to C6 alkyl bearing an C6 to C16 aromatic or alkyl substituted aromatic group, all optionally substituted on the aromatic group with one or two Cl, Br, I, F, CF₃, and CF₃O; all alkyl and cycloaliphatic groups optionally substituted with one or two carbon-carbon double bonds; all aliphatic and cycloaliphatic groups optionally substituted with —H, —OR⁶, —Si(OR⁶)₃, or —C(O)OR⁶; wherein R⁶ is C1 to C16 linear or branched alkyl group; or C6 to C16 aromatic group; and X is NH, O, or nothing;
   wherein
if p is 1, R² is a divalent C1 to C8 linear or branched alkyl, a C1 to C6 alkyl bearing an C6 to C10 aromatic or alkyl substituted aromatic group, a —(CH₂CH₂O)ₙ(CH₂CH₂)— group with n being 1 to 4,
   wherein
if p is 2, R² is Formula (IIIa) and if p is 3, R² is Formula (IIIb) 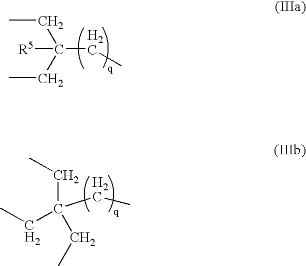
   wherein
q is 0 or 1; and R⁵ is H, a C1 to C5 linear alkyl group;
   wherein
if p is 1, 2, or 3, X is chosen from O or NH, Y is chosen from O, NH, or nothing, with the proviso that if X is O, Y cannot be O, and if X is NH, Y cannot be NH, Z is chosen from O, NH, or nothing; formula (IIA) 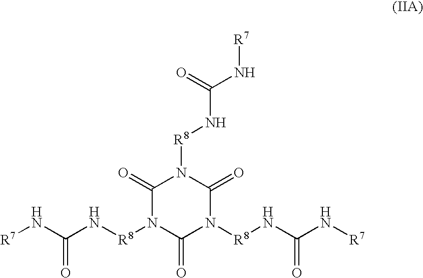
   wherein
R⁷ is a monovalent C1 to C16 linear or branched alkyl group; C1 to C6 linear or branched alkyl group bearing a C5-C16 cycloaliphatic group; C5-C16 cycloaliphatic or alkyl substituted cycloaliphatic group; C6 to C16 aromatic or alkyl substituted aromatic group; C1 to C6 alkyl bearing an C6 to C16 aromatic or alkyl substituted aromatic group; optionally substituted on the aromatic group with one or two Cl, Br, I, F, CF₃, and CF₃O; all aliphatic and cycloaliphatic groups optionally substituted with one or two carbon-carbon double bonds, all aliphatic and cycloaliphatic groups optionally interrupted by one or two —OC(O)— groups, all aliphatic and cycloaliphatic groups optionally substituted with —OH, —OR⁶, —Si(OR⁶)₃;
   wherein
R⁶ is C1 to C16 linear or branched alkyl group; or C6 to C16 aromatic group; and
R⁸ is a divalent C3 to C8 linear or branched alkylene group; C1 to C6 linear or branched alkylene group bearing one or two C5-C8 cycloaliphatic groups; C5-C16 cycloaliphatic or alkyl substituted cycloaliphatic group; C6 to C16 aromatic or alkyl substituted aromatic group; C1 to C6 alkyl bearing an C6 to C16 aromatic or alkyl substituted aromatic group; formula (IIB) 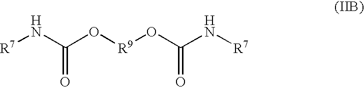
   wherein
R⁹ is a divalent C2 to C18 linear or branched alkylene group; C1 to C6 linear or branched alkylene group bearing a C5-C16 cycloaliphatic group; C5-C16 cycloaliphatic or alkyl substituted cycloaliphatic group; —(CH₂CH₂O)ₘ(CH₂CH₂)— group with m being 1 to 4, and R⁷ is as defined above; formula (IIC) 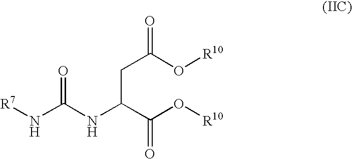
   wherein
R⁷is as defined above and R¹⁰ is —(CH₂)ᵤ—(CF₂)ᵥ—CF₃, with u equal to 1 to 4, and v equal to 0 to 9; and formula (IID) 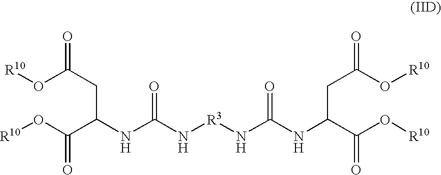
   wherein
R³is as defined above and R¹⁰ is as defined above.

Formulae (IV) to (XVI) illustrate H-bonded organogelators useful in forming the composite materials of the invention. These structures are defined by formula (I) with p equal to 1, X equal to NH, Y equal to O and Z equal to NH, with R²-R⁴ as defined above. The H-bonded organogelators (IV) to (XVI) are prepared by first reacting an amino alcohol component with a diisocyanate component. The reaction temperature, conditions and reactant concentration are selected to favor the formation of the intermediate addition product, a bis-urea diol derivative. Further reaction with a mono-isocyanate component forms the following H-bonded organogelators.

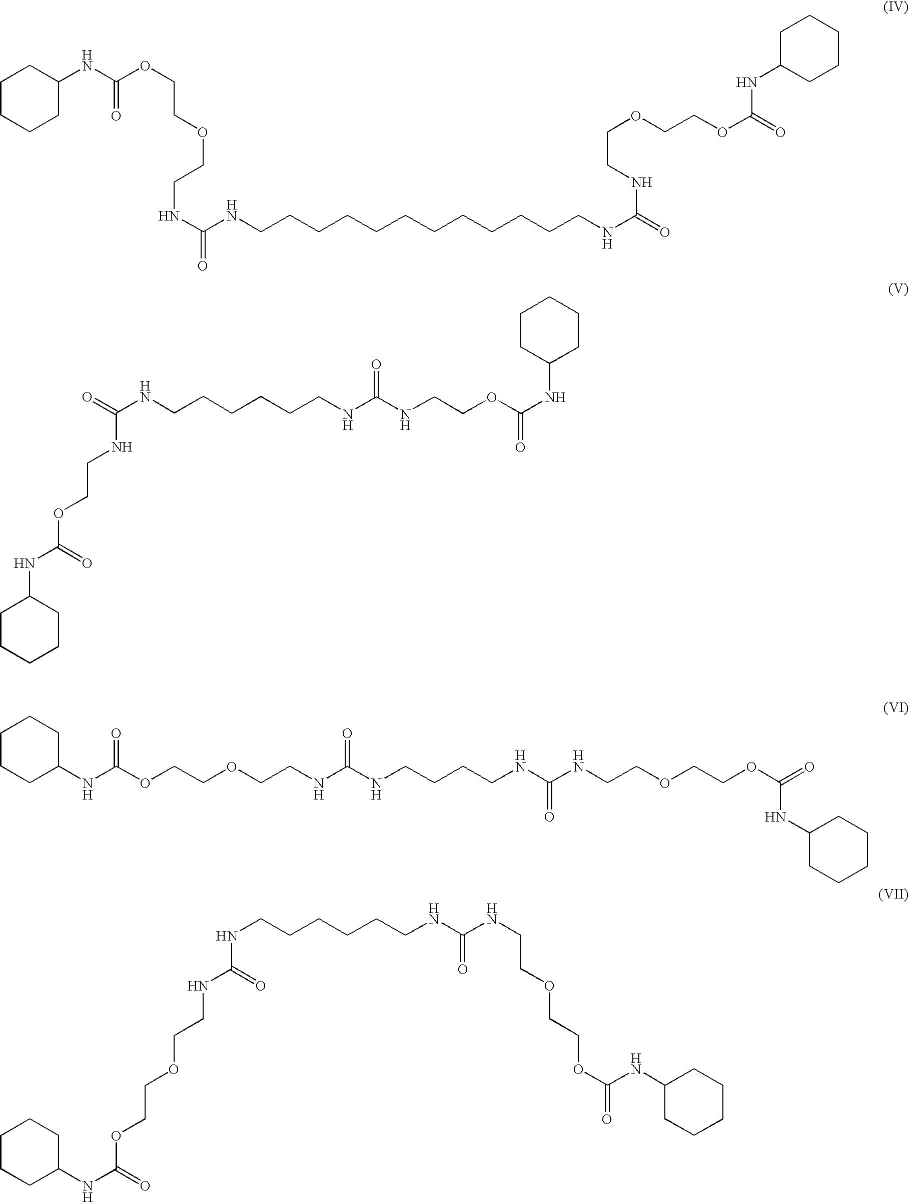

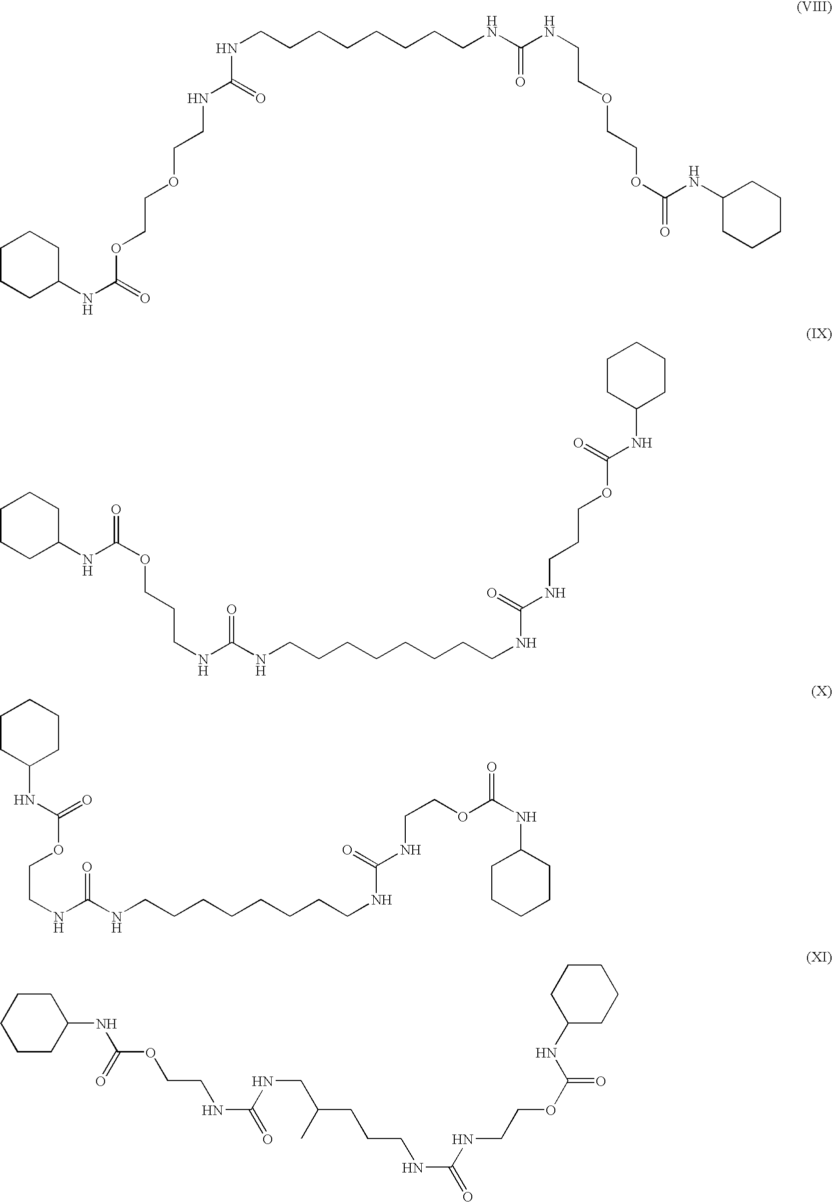

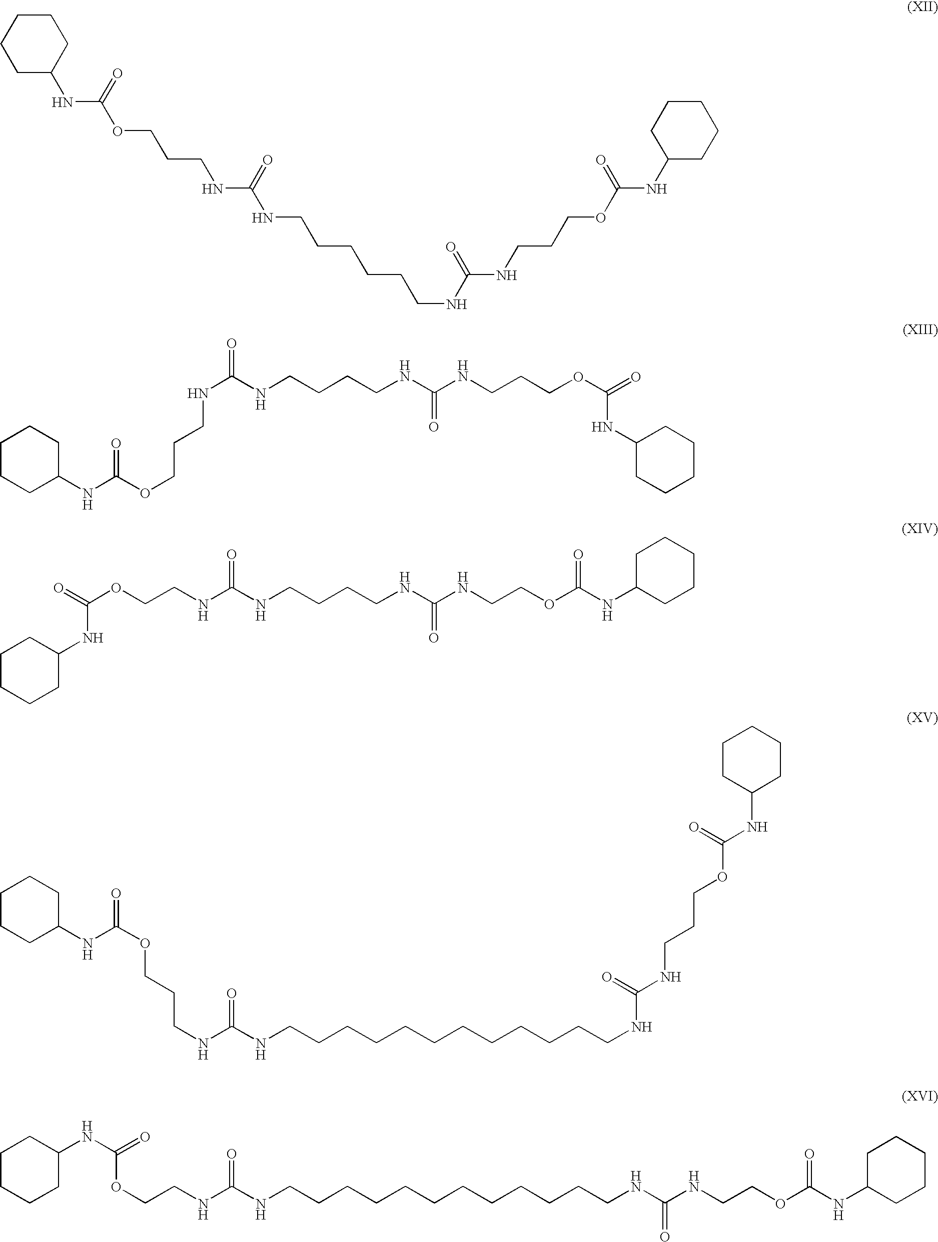

Other H-bonded organogelators useful in the present invention include compounds exemplified by the structure of formula (XVII). These structures are defined by formula (I) with p equal to 1, X equal to O, Y equal to NH and Z equal to NH, with R²-R⁴ as defined above. These H-bonded organogelators are prepared by first reacting an amino alcohol component with a monoisocyanate component. The obtained urea-alcohol is further reacted with a diisocyanate component.

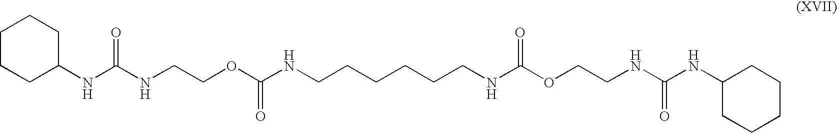

Other H-bonded organogelators useful in the present invention include compounds having the structures of formulae (XVIII) to (XXII). These structures are defined by formula (I) with p equal to 1, X equal to NH, Y equal to O and Z equal to nothing, with R²-R⁴ as defined above. These H-bonded organogelators are prepared by first reacting an amino alcohol component with a diisocyanate component. The reaction temperature and reactant concentration is selected to favor the selective formation of the intermediate addition product. Further reaction with an acylation equivalent (known to those skilled in the art, such as acyl chlorides, carboxylic anhydrides) forms the following H-bonded organogelators.

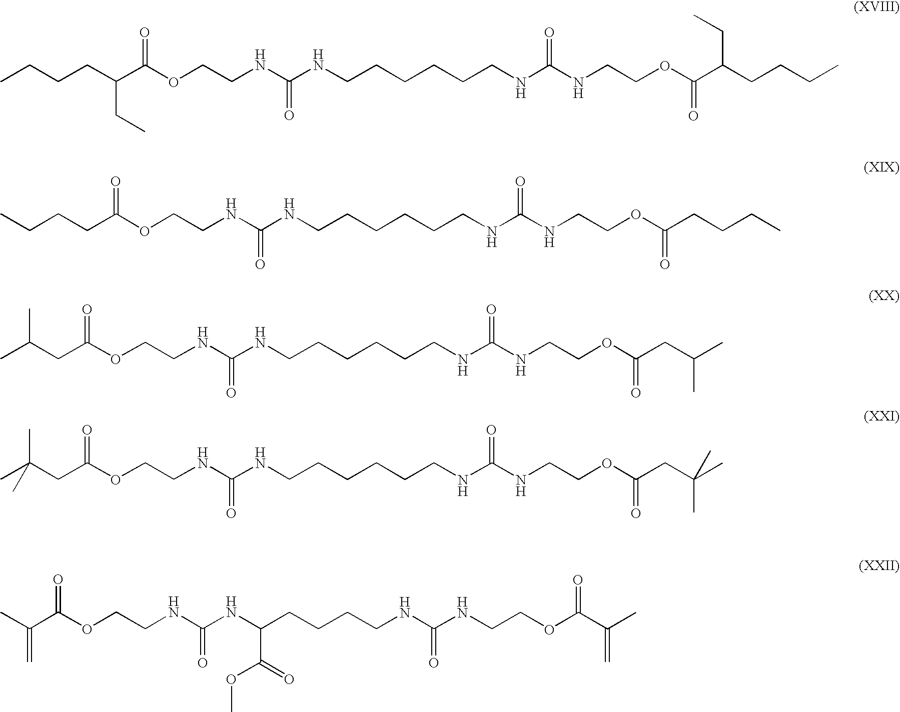

Other H-bonded organogelators useful in the present invention include compounds having the structures of formulae (XXIII) and (XXIV). These structures are defined by formula (I) with p equal to 2, X equal to NH, Y equal to O and Z equal to NH, with R³-R⁴ as defined above, with R² equal to 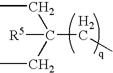
with R⁵ equal to H and q equal to 0. These organogelators are prepared by first reacting an amino bis-alcohol component with a diisocyanate component. The reaction temperature, conditions and reactant concentration is selected to favor the formation of the intermediate addition product, a bis-urea tetraol derivative. Further reaction with a mono-isocyanate component forms the following organogelators.

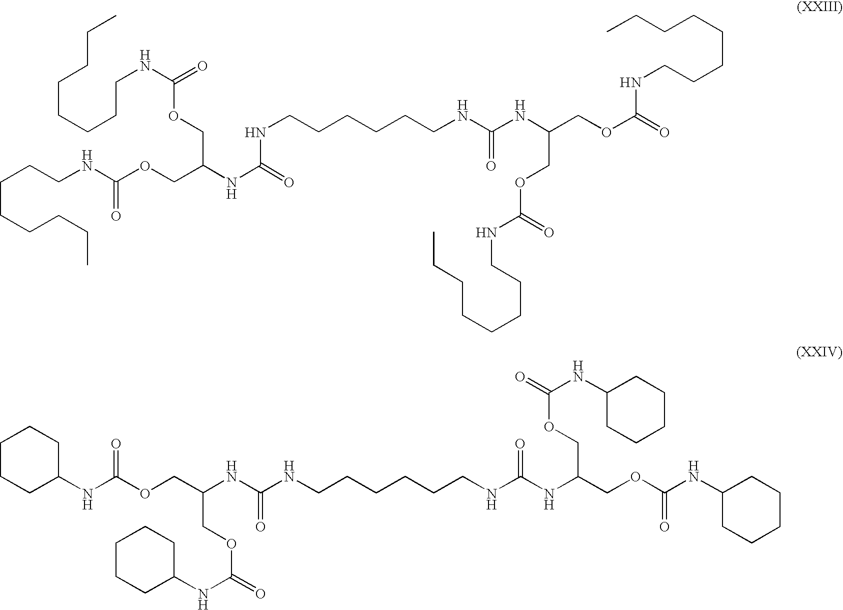

Other H-bonded organogelators useful in the present invention include compounds having the structure of formula (XXV). These structures are defined by formula (I) with p equal to 3, X equal to NH, Y equal to O and Z equal to nothing, with R³-R⁴ as defined above, with R² equal to

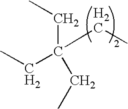

These organogelators are prepared by first reacting an amino tris-alcohol component with a diisocyanate component. The reaction temperature, conditions and reactant concentration is selected to favor the formation of the intermediate addition product, a bis-urea hexa-ol derivative. Further reaction with an acylation equivalent known to those skilled in the art, such as acyl chlorides and carboxylic anhydrides, forms the following organogelator.

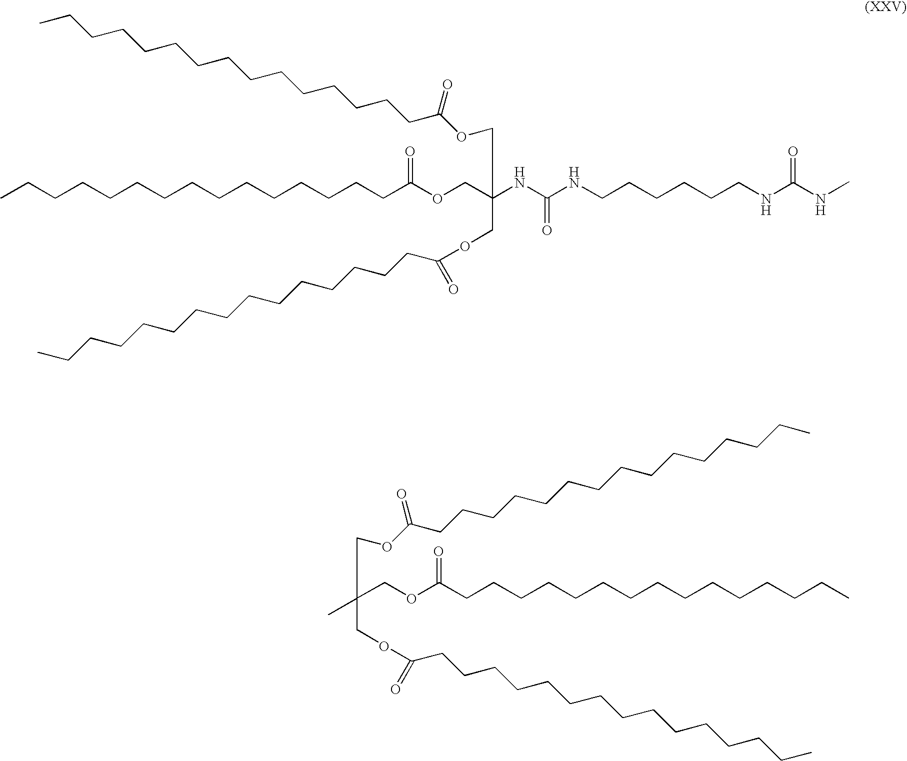

Other H-bonded organogelators useful in the present invention include compounds having the structures of formulae (XXVI) to (XXIX). These structures are defined by formula (I) with p equal to 0, X equal to NH, with R² is as defined above and R³ is a branched alkylene group or a cycloaliphatic ring. These organogelators agents are prepared by reacting a diisocyanate, in the indicated examples 2-methyl-1,5-pentamethylene diisocyanate or trans-1,2-cycloheane diisocyanate, with two equivalents of monoamine. For instance, Moreau, et al. (J. Am. Chem. Soc. (2001) 123, 1509) discloses the synthesis of structure (XXIX).

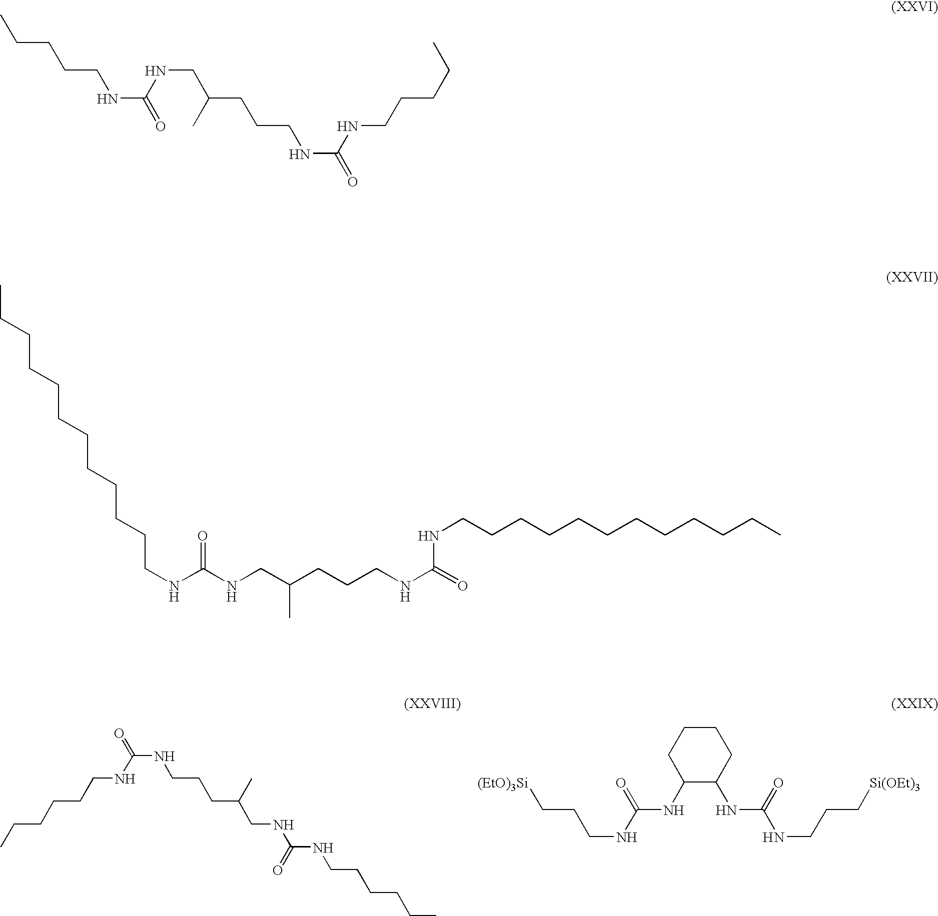

Other H-bonded organogelators useful in the present invention include compounds of formulae (XXX) to (XXXV). These structures are defined by formula (I) with p equal to 0, X equal to NH, with R² as defined above and R³ being divalent group selected from C3 to C18 linear or branched alkylene groups interrupted by two —OC(O)— groups. These organogelators are prepared by first reacting an amino alcohol component with a monoisocyanate component. This intermediate urea alcohol is further reacted with a difunctional acylating component equivalent, such as bis-acyl chlorides or bis-carboxylic anhydrides, to form the organogelator. Alternatively, the parent bis-carboxylic acids may be utilized in a selective esterification reaction to form the desired products.

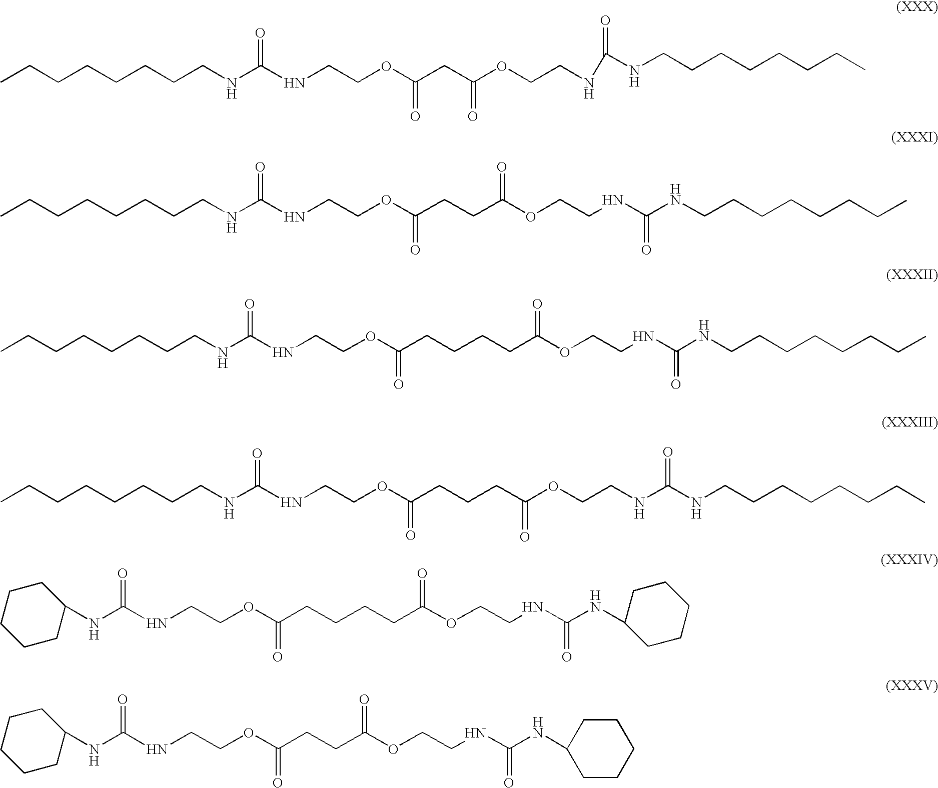

Other H-bonded organogelators useful in the present invention include compounds of formulae (XXXVI) to (XLII). These structures are defined by formula (I) with p equal to 1, X equal to NH, Y equal to nothing, with Z equal to O, with R²-R⁴ as defined above. These organogelators are prepared by reacting two equivalents of an alpha-amino ester or beta-amino ester component with a diisocyanate component. Alternatively, two equivalents of a glycin-ester derived isocyanate or a longer chain ester isocyanate can be used in a reaction with a diamine to form these structures.

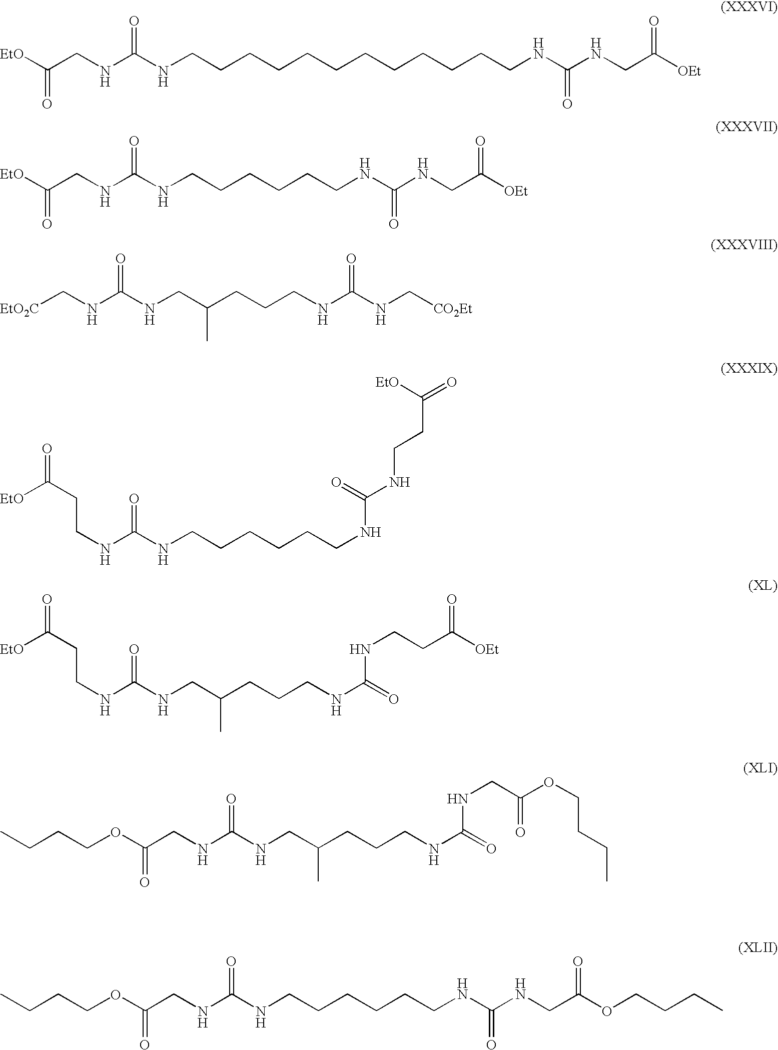

Other H-bonded organogelators useful in the present invention include compounds of formulae (XLIII) thru (XLV). These structures are defined by formula (IIA), with R⁷-R⁸ as defined above. These organogelators are prepared by reacting three equivalents of amine or amino alcohol with an isocyanurate-trimer component, procedures for which are disclosed in U.S. Pat. No. 4,677,028, hereby incorporated by reference. The amino alcohols may be further esterified to provide esters.

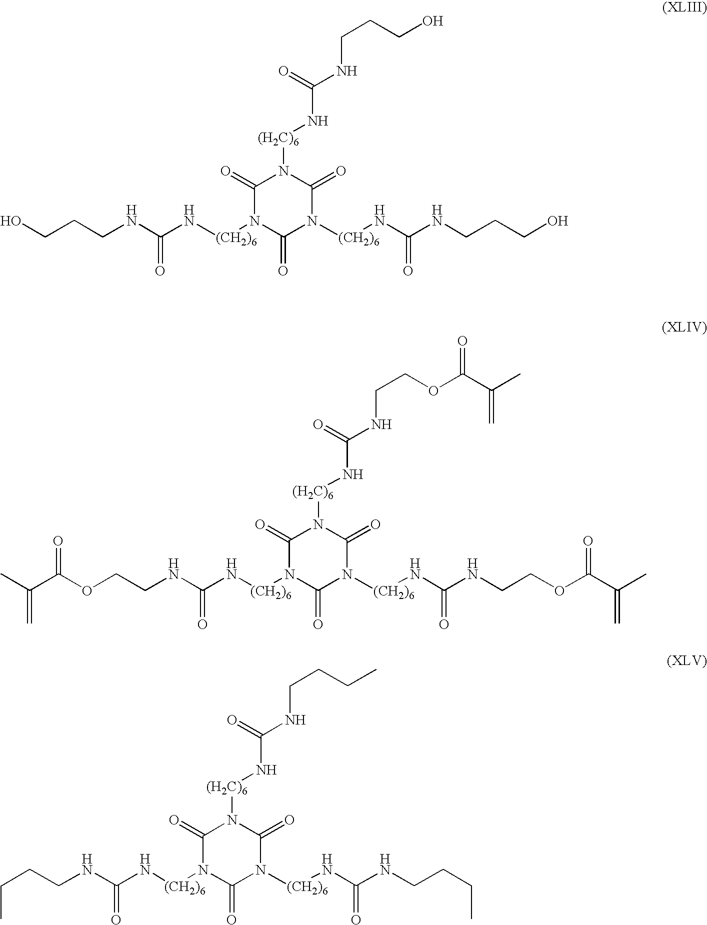

The isocyanurate-trimer used for the preparation of the compounds of formula (IIA) are preferably derived from an diisocyanate containing 5-14 carbon atoms, particularly from a diisocyanate containing 8-12 carbon atoms, and more preferably from hexamethylene diisocyanate. Examples of suitable diisocyanates include trimethylene diisocyanate, tetramethylene diisocyanate, hexamethylene diisocyanate, cyclohexyl-1,4-diisocyanate, dicyclohexylmethane-4,4′-diisocyanate, 1,5-dimethyl-2,4-bis(isocyanatomethyl)benzene, 1,5-dimethyl-2,4-bis(ω-isocyanatoethyl)benzene, 1,3,5-trimethyl-2,4-bis(isocyanatomethyl)-benzene, 1,3,5-triethyl-2,4-bis(isocyanatomethyl)benzene, a heterocyclic diisocyanate available as Desmodur TT™ of Bayer, dicyclohexyldimethyl-methane-4,4′-diisocyanate, 1,4-toluene diisocyanate, 2,6-toluene diisocyanate and diphenylmethane-4,4′-diisocyanate. If desired, use may also be made of a heterocyclic trimer of 2 or 3 different diisocyanates. Optionally, use may be made of mixtures of the heterocyclic triisocyanates referred to above.

Other H-bonded organogelators useful in the present invention include compounds of formulae (XLVI) thru (LI). These structures are defined by formula (IIC) and (IID), with R³, R⁷ and R¹⁰ as defined above. These organogelators are prepared by esterifying N-butoxycarbonyl (BOC)-aspartic acid with fluoro alcohols as described in by Beckman, et al. (Science (1999) 286, 1540-1543). Deprotection of the amine with trifluoroacetic acid in dichloromethane is followed by treatment with either a mono or diisocyanate to provide structures (IIC) and (IID), respectively.

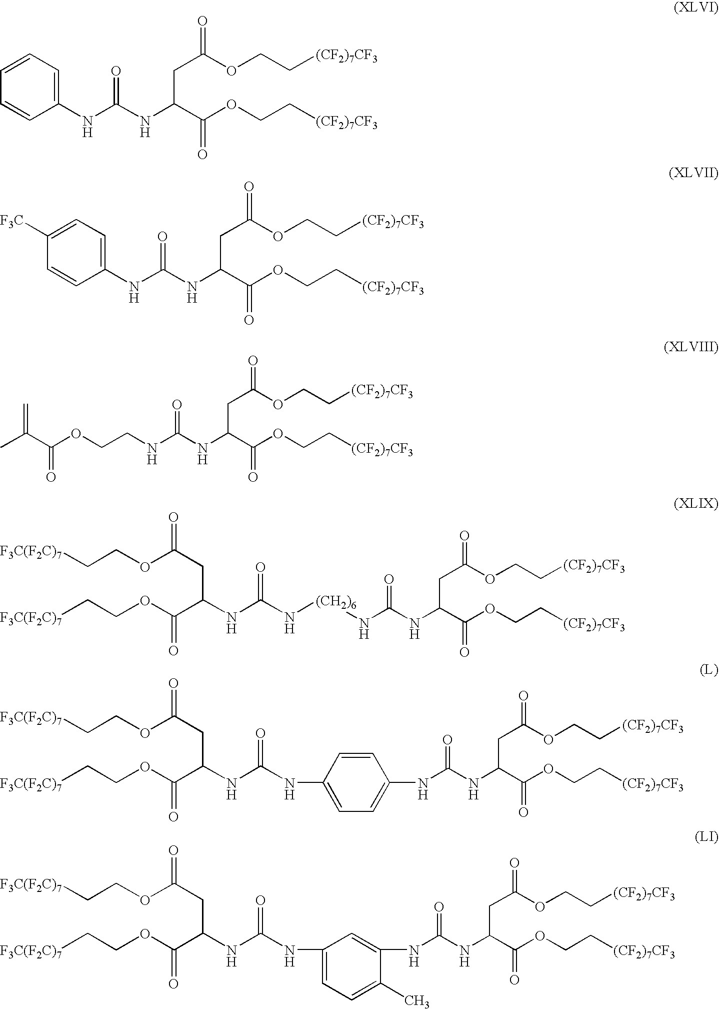

Preferred H-bonded organogelators include compounds of formulae (V), (XXII), (XXVI), (XXIX), (XL), (XLI), (XLIII) and (XLVI). The syntheses of many of the organogelators listed above are described in U.S. provisional application No. 60/643,514, hereby incorporated by reference. The syntheses of organogelators are further exemplified by the following procedures for specific organogelators used in the examples.

Compound of structure (XXII), used in the examples, was prepared as follows: To a stirred suspension of 2-aminoethyl methacrylate.HCl (9.9 g, 0.054 mol) and chloroform (70 mL), cooled to −5° C. under nitrogen, was added triethylamine (7.5 mL, 0.054 mol). The solution was stirred at 0° C. for 10 minutes. Lysine diisocyanate (5.4 g 0.0255 mol) was added dropwise, maintaining a temperature of about 0° C. The mixture was stirred for two days at room temperature. Then solvent was removed at 35° C. and the resulting semi-solid extracted with water, diethyl ether, and finally ethyl acetate. The ethyl acetate organic phases were combined, dried over magnesium sulfate, filtered and concentrated to provide 38.0 g of a gel-like material. This material was dried overnight under ambient condition and then under high vacuum to give of a pale yellow solid (10.4 g, 87%). LC/MS analysis revealed that the purity of the solid was greater than 92% (M+H=471).

Compound of structure (XLIII), used in the examples, was prepared as follows: To an ice cooled solution of 3-amino-1-propanol (17.27 g) and chloroform (450 mL) was added DESMODUR® N 3300A (20.00 g, Bayer Materials, Pittsburgh, Pa.) in chloroform (45 mL) over about 2 hours. After the addition was finished, the reaction was allowed to stir overnight at ambient temperature. The mixture was diluted with ethyl ether (300 mL) and stirring continued for 2 h. A white precipitate was isolated by filtration and washed with acetonitrile (200 mL). The solid was collected and dried in a vacuum drying oven to provide a white solid (27.87 g). LC/MS analysis revealed that this solid contained 75% of the desired 3-amino-1-propanol-capped HDI-trimer (XLIII).

π-Stacked Organogelators

Aromatic π-stacking interactions are important assembling forces in nature (see Waters, Curr. Opinion Chem. Bio. (2002) 6, 736). Organogelators that contain π-stackable groups have been reported on several occasions, and in most cases π-stacking interactions in conjunction with hydrogen bonding, metal-metal interactions or van der Waals interactions cause organogelation. In rare instances and under special circumstance, for instance, low temperature and/or high concentration, organogelation of π-stacked systems has been observed in the absence of another interaction mode (see Ajayaghosh, J. Am. Chem. Soc. (2001)123, 5148). Thus, π-stacked organogelators useful in the invention include those that may have other modes of interactions as well, such as H-bonding, van der Waals interactions and metal-metal interactions.

The π-stacked nanoweb gels useful in the invention include those derived from π-stacked organogelators such as anthracene-based compounds including anthracenes, anthraquinones, and phenazines, described in US 2004/0065227, Breton, et al., hereby incorporated by reference; binary anthracene-based gelators such as reported by Shinkai (Org. Biomol. Chem. (2003)1, 2744); 2,3-bis(n-alkoxy)anthracenes such as 2,3-bis(n-decyloxy)anthracene as reported by Desvergne (Chem. Comm. (1991) 6, 416); all hereby incorporated by reference.

Other π-stacked organogelators useful in the invention include trinuclear gold-pyrazolate gelators as reported by Aida (J. Am. Chem. Soc. (2005) 127, 179); π-stacked porphyrin aggregates as reported by Shinkai (J. Am. Chem. Soc. (2005) 127, 4164); photochromic organogelators that incorporate photostimulable 2H-chromene units, as reported by Vögtle (Langmuir (2002) 18, 7096); and pyrene-derived one- and two-component organogelators as reported by Maitra (Chem. Eur. J. (2003) 9, 1922); all of which are hereby incorporated by reference.

A preferred π-stacked organogelator for the invention is compound of formula (LII) the synthesis of which is described in J. Am. Chem. Soc. (2004)136, 10232. 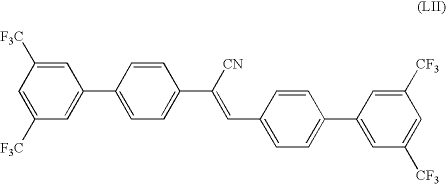
Solvents for Organogelators

The process and composite materials of the invention encompass the use of a wide variety of organogelators. Solvents and specific conditions for forming gels of many organogelators are available in the patent and scientific literature. However, the one skilled in the art will recognize that many specific gelators may not be fully described in the available art so as to be useful in the invention without some preliminary gelling experimentation. For such cases, a methodology has been developed for matching a solvent system with specific gelators to allow efficient gel formation. In general if the gelator is too soluble, it will dissolve without forming a gel even at high concentrations. If the gelator is not soluble enough, it may or may not dissolve at high temperature, but precipitate again as the temperature is lowered. Ideally, the organogelator should dissolve in a solvent at some temperature and assemble into a network. Preferably the gelators have a solubility in a solvent system of about 0.1 to 5 wt % at a temperature/pressure above the gel point. Changing the temperature and/or pressure, adjusting the solvent composition, adjusting the pH, altering the shear-state of thixotropic systems, or a combination of parameters can be used to induce gelling.

A simple screening protocol for evaluating thermo-reversible gels allows evaluation of a specific gelator with different solvents in parallel using a reactor block. In a typical set-up, 2 wt % slurries of the organogelator in solvents of varying polarities can be prepared, for example a series may include: water, n-butanol, ethanol, chloroform, toluene, and cyclohexane. The vials are then placed in a reactor block for 1 h while stirring at a temperature close to the boiling point of the solvent to induce dissolution. In the case of some gelators, for instance, urea-based gelators, additives such as lithium salts, for instance lithium nitrate, can be added in small amounts (0.1 to about 10 wt %, based on the amount of organogelator) as described in U.S. Pat. No. 6,420,466, hereby incorporated by reference. Upon cooling, gelation may occur and is evident by formation of a translucent to opaque appearance without the formation of solid crystals, and/or a significant increase in viscosity. If gelation does not occur, one can screen different solvents or solvent mixtures as well as different additives and additive levels. If a gelator sample is soluble in a given solvent, but organogelation does not occur, then one can either raise the gelator concentration to, for instance, 3 or 5 wt % and repeat the heating cycle, or one can lower the solubility of the compound by using a solvent mixture of lower polarity.

Preferred solvents for H-bonded organogelators are those having H-bonding capability that allows disruption of intermolecular H-bonding between solute molecules. Water, ammonia, alcohols, sulfoxides, esters, ethers, amines, amides, and lactams are useful. H-bonded organogelators often exhibit very high solubility in the lower alcohols such as methanol and ethanol. Whereas H-bonded organogelators often exhibit lesser solubility in the higher aliphatic and cyclic alcohols including propanol, butanol, hexanol, cyclohexanol and isomers thereof, making them more desirable for use as gelating solvents. In one embodiment, preferred solvents are those that are miscible with supercritical carbon dioxide. Specific solvents that are especially useful in forming gelling mixtures include: water, the lower aliphatic and cyclic alcohols such as ethanol, isopropyl alcohol, butanol, hexanol, cyclohexanol, cylopentanol, and octanol; aliphatic and aromatic hydrocarbons such as hexane, cyclohexane, heptane, octane, toluene, xylenes, and mesitylene; amides and lactams such as N-methylpyrrolidone, pyrrolidone, caprolactam, N-methyl caprolactam, dimethyl formamide, and dimethyl acetamide; ethers such as dibutyl ether, dipropyl ether, methyl butyl ether; ether alcohols such as 2-methoxyethanol, 2-butoxyethanol, and others in the class of ethers known as CELLUSOLVES®; esters such as ethyl acetate, butyl acetate and the like; aliphatic and aromatic halocarbons such as dichloromethane, 1,2-dichloroethane, 1,1,1-trichloroethane and dichlorobenzene. Butanol, and especially n-butanol, is a preferred solvent for use in the process of the invention.

Supercritical fluids, those above the critical point pressures and temperatures, can act as solvents for organogelators in the formulation of gelling mixtures. A particular preferred supercritical fluid is carbon dioxide.

Gelling Mixture

The gelling mixture, as applied into the porous support, can be in the form of: a homogeneous isotropic solution; a gel that can be shear-thinned (thixotropic) to form a fluidized gel; or a gel in the form of a film, sheet or powder that can be melted to form a fluidized gel. Formulation of a suitable gelling mixture to practice the invention depends upon the methods anticipated for applying the gelling mixture and gelling the impregnated support. For instance, in a preferred embodiment the gelling mixture is a gel that can be shear-thinned prior to, or during, application to form a fluidized gel. The fluidized gel can then penetrate the porous support to provide an impregnated support. Organogelators suitable for formation of thixotropic gels include those of formulae (I) (IIA), and (IIB), and compounds of formula (IIA) are especially suitable. A specific preferred compound for formation of thixotropic gels is (XLIII).

In another preferred embodiment the gelling mixture is a homogeneous isotropic solution that, if so desired, is heated above ambient conditions. After applying the solution to provide an impregnated support, the impregnated support can be cooled to induce gelling of the impregnated support. Organogelators suitable for formation of homogeneous isotropic solutions include those of formulae (I) and (IIA-D) and compounds of formula (I) and (IIC) are especially suitable. Specific preferred compounds for formation of homogeneous isotropic solutions include (V), (XXII), (XXVI), (XXIX), (XL), (XLI), (XLVI), and (XLIII).

Suitable gelling mixtures for the invention preferably comprise 0.01 to 20 wt % of one or more organogelators, and preferably, 0.5 to 5 wt %, with the remainder being solvent and other processing aids, for instance lithium salts.

Applying the Gelling Mixture

Applying the gelling mixture into the porous support can be done by a variety of methods including one or more of the steps of: spraying, coating, blading, casting laminating, rolling, printing, dipping, and immersing; and allowing gravity, diffusion, and/or flow through of the gelling mixture into the porous support, and, optionally, applying pressure, heat or vacuum. Spraying, coating, blading, casting and immersing are preferred methods for applying thixotropic gels and spraying and blading are most preferred. Laminating and heating is a preferred method for applying solid gels in the form of films. Spraying, coating, blading, casting, printing and immersing or dipping are preferred methods for applying homogeneous isotropic solutions. In some instances, it is advantageous to remove excess gelling mixture from the surface of the porous support, such as by scraping or the like.

Gelling the Impregnated Support

Gelling the impregnated support can be accomplished by a variety of methods depending upon the nature of the gelling mixture. In one preferred embodiment, wherein the gelling mixture is a thermo-reversible gel, the gelling step comprises cooling of a homogeneous solution of the gelling mixture in the impregnated support. The gelling mixture can be pre-heated to provide a homogeneous solution or can be cooled from ambient temperature, if so desired. Another preferred embodiment, wherein the gelling mixture is a gel applied with shearing, the gelling step can comprise abating the shearing in the impregnated support. This can be accomplished by allowing the impregnated support to sit for a period of time in the absence of shear. In another embodiment, wherein the gelling mixture is sensitive to pH, the impregnated support can be subjected to a change in pH. In other embodiments the solvent can be modified by addition of a non-solvent in a solvent exchange, partially removed, or a solubilizing agent, such as lithium salts can be removed, to provide a gel.

Gel Drying

Drying the gel, or removing the solvent from the gel, will leave behind the porous nanoweb on and/or within the porous support. Drying can be achieved through a variety of routes including freeze drying, ambient drying, oven, radiant and microwave heating, vacuum drying (with or without heat), or critical point drying (CPD). Alternatively the solvent can be exchanged with another fluid, in a fluid-fluid extraction process or a supercritical fluid extraction (SFE), which then can be removed from the gel via one of the aforementioned drying techniques, if so desired. A preferred method of drying is solvent exchange followed by critical point drying.

The drying method can have a profound effect on the resultant nanoweb structure as the various drying methods occur over different time scales, place different stresses on the nanoweb structure, and involve the crossing of different phase boundaries.

To preserve the 3-D network of the gel structure in the dried composite material, the stresses of drying, particularly those due to capillary forces and solvent diffusion, must be considered. Drying with a supercritical fluid (SCF) minimizes these stresses as they exhibit a density typical of a liquid but transport properties like a gas. A preferred drying method is CPD, wherein the gel solvent is exchanged for liquid carbon dioxide, which is subsequently brought to a temperature and pressure above its critical point and then slowly vented from the composite material. Alternatively the solvent can be directly exchanged for a SCF in a SFE extraction, followed by venting of the SCF or gas from the structure. If the liquid carbon dioxide or desired SCF is not directly soluble with the solvent, then an intermediate transfer solvent, which is soluble in liquid carbon dioxide or the desired SCF, can be used. The transfer solvent is exchanged for the gelling solvent and the above procedures are subsequently used. A preferred transfer solvent for use with supercritical carbon dioxide is ethanol, but other solvents, as listed above, may be used as a transfer solvent, if so desired.

Carbon dioxide is the preferred SCF for both CPD and SFE. Other solvents useful as SCF include nitrous oxide, FREON® 13, FREON® 12, F FREON® 116, and FREON® TF. U.S. Pat. No. 4,610, 863, hereby incorporated by reference, discloses a number of useful SCF's and their properties relating to CPD. Supercritical carbon dioxide shows good pressure dependent miscibility with a broad array of solvent materials and thus can be tuned for a given process.

In vacuum drying, the driving force for solvent removal from the impregnated material is increased such that the solvent can be removed more readily, and thus without disruption of the assembled nanoweb. Heat can be used in combination with vacuum if it does not disrupt the gelled assembly. Ambient drying is performed at atmospheric pressure and optionally with heat. In freeze drying, the impregnated material is rapidly frozen (on a time scale that does not allow for rearrangement of the gel structure) and solvent is subsequently sublimed away to provide the composite material.

Another embodiment of the process of the invention includes the independently optional steps of: annealing the dried nanoweb; and washing the dried nanoweb with a non-solvent. Annealing may be accomplished by heating the nanoweb composite materials at a temperature below the nanoweb melting point. Such a process may be desirable when an improvement in the crystallinity of certain nanoweb formulations is desired.

### Uses

The composite materials of the invention can be used as gas-solid, gas-liquid, liquid-liquid, and liquid-solid filters. The gas can be air, carbon dioxide, oxygen, nitrogen, a noble gas, or any other process gas used in industrial or commercial processes. The liquid can be an organic solvent, oil, water, an aqueous solution, or some combination thereof. The liquid can contain a biological or chemical substrate. Air, water, and solvent filters are preferred applications of the composite materials. Filters can be in the form of nonwoven pleated or unpleated cartridge filters, glass or other ceramic microfiber filters.

Since the individual organogelator molecules making up the nanoweb are not covalently bonded to one another, there are conditions in which the porous nanoweb can be easily dissolved and removed from the porous support. In applications wherein trapped material is of significant interest, for instance, biological material, radioactive material, etc., the solubility of the nanoweb is a particular advantage, as it can allow release and recovery of the trapped material. Such flexibility can be useful in recycling and recovery of composite materials as well.

The composite materials of the present invention may also find use in barrier fabric applications, such as for protective clothing or construction wrap, in which good barrier against liquid penetration is provided while maintaining good air and moisture vapor permeability.

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### EXAMPLES 1-8

In the following Examples (Table 1), unless otherwise indicated, a composite nanoweb material sample was formed by adding 2 wt % of the indicated organogelator to the indicated solvent in a reaction vial to form a slurry, immersing a several square centimeter sample of the indicated support material into the slurry, heating the immersed sample to a temperature between about 80-110° C., stirring for a time sufficient to form a homogeneous solution and cooling to form a gel. The composite material so formed was removed from the reaction vial, and where necessary, excess gel was removed from the sample composite material with tweezers.

Drying and nanoweb formation was conducted using one of two methods: critical point drying (CPD) or vacuum oven drying (VO).

A critical point drying apparatus (Balzers CPD 020) was used for the CPD. The instrument consisted of a chamber with a stirrer and inlet and outlet ports equipped with metering valves. The CPD chamber was filled half full with approximately 20 mL of the ethanol, which was used as the transfer solvent. The sample was rinsed with the transfer solvent prior to loading it into the holder. The sample was placed in a holder consisting of a mesh basket designed for CPD made of metal or plastic and immersed into the transfer solvent in the drying chamber. The chamber was sealed and cooled to 15° C. Carbon dioxide liquid was added to the chamber through the input port to fill the chamber to volume. The mixture was stirred for about 5 min. The outlet port valve was opened to slowly drain the liquid so the chamber was about half full. This successive dilution process was repeated 5 times with carbon dioxide. After the final dilution and draining to half full, the temperature was increased to 40° C. such that the carbon dioxide reached its critical point as indicated by the pressure gauge (between 80-85 bar at 40° C.). The carbon dioxide was slowly vented from the chamber over the course of 0.25 h to ambient pressure to provide a composite material. The sample was stored over desiccant (DRIERITE®, anhydrous calcium sulfate) in a sealed container.

Vacuum oven drying (VO) was conducted with a laboratory vacuum oven (VWR Scientific Products). The treated sample material was placed on an aluminum tray and loosely covered with another aluminum tray. The trays were transferred into the oven and the sample was dried at 30° C. overnight (about 16 h). During the first 0.5 h of drying, full vacuum was applied with a nitrogen purge resulting in a reading of 26 in Hg on the vacuum gauge. The remainder of the drying cycle was performed with full vacuum without a nitrogen purge (resulting in 29 in Hg).

Dual beam (DB, electron and focused ion beam) microscopy was used to characterize the microstructure of the composite material samples. In the DB microscopy technique, a focused ion beam is used to sculpt the material prior to the SEM imaging. The ion beam directs fast ions onto the sample resulting in the ability to essentially mill materials at the microscopic scale. Milling only occurs where the rastered beam hits the sample surface, so a precise cut can be made into the sample. By controlling the milling process, a small portion of the sample can be removed. Subsequent SEM images of the sample allow for a quasi-cross-sectional view into the depth of the sample. Table 1 indicates the Figure numbers illustrating the indicated samples.

TABLE 1

| | Organogelator | | | Drying | |
|---|---|---|---|---|---|
| Ex. | Formula # | Solvent | Support | Technique | Figure # |
| 1 | V | n-butanol | Tyvek ® | CPD | 1 and 2 |
| 2 | V | n-butanol | Tyvek ® | VO | 3 |
| 3 | V | n-butanol | SUPOR ® 800 | CPD | 4 |
| 4 | V | n-butanol | SUPOR ® 800 | VO | 5 |
| 5 | XXVI | toluene | Tyvek ® | VO | |
| 6 | LI | toluene | SUPOR ® 800 | VO | |
| 7 | V | n-butanol | Sontara ® | CPD | |
| 8 | V | n-butanol | Sontara ® | VO | |

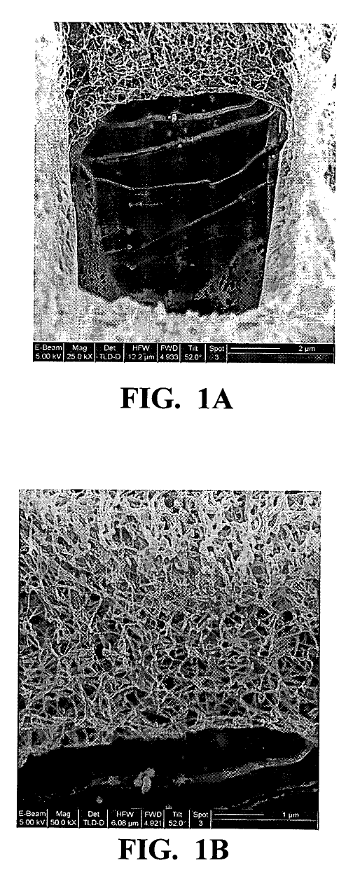

FIG. 1 illustrates the DB SEM micrograph of Example 1 at a) 25000× and b) 50000× magnification showing the nanoweb on and within the porous support.

FIG. 2 illustrates the SEM micrograph of Example 1 at 5000× magnification showing the nanoweb on the porous support.

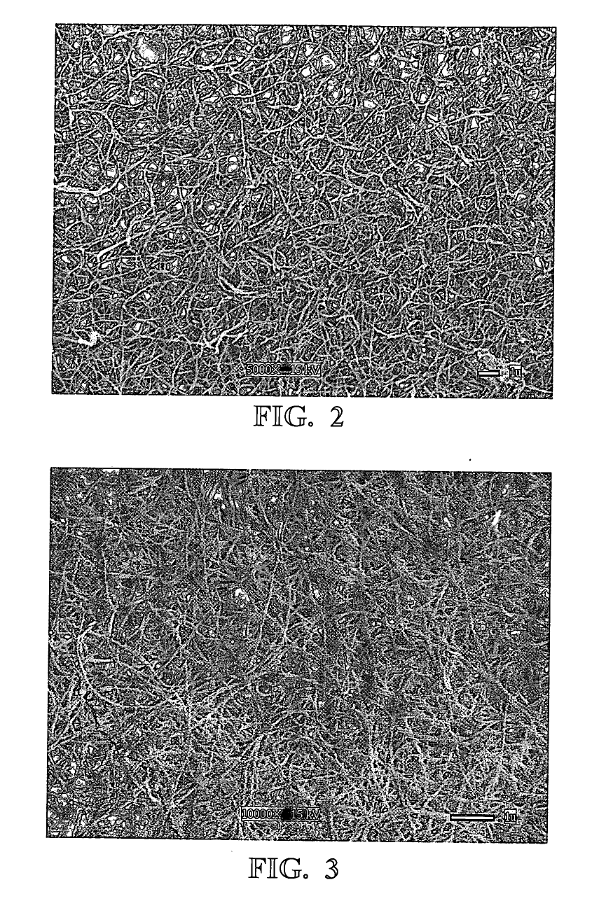

FIG. 3 illustrates the SEM micrograph of Example 2 at 1000× magnification showing the nanoweb fibers on the porous support.

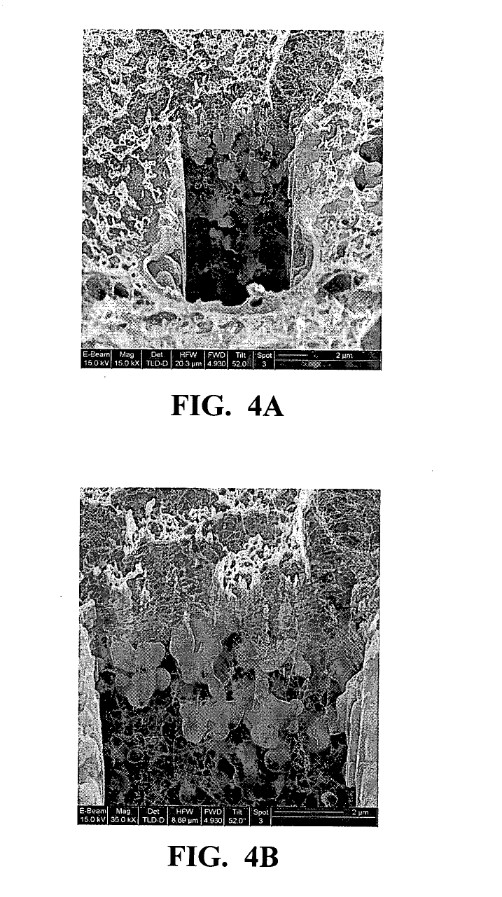

FIG. 4 illustrates the DB-SEM micrograph of Example 3 at a) 15000× and b) 35000× magnification showing the nanoweb within the porous support.

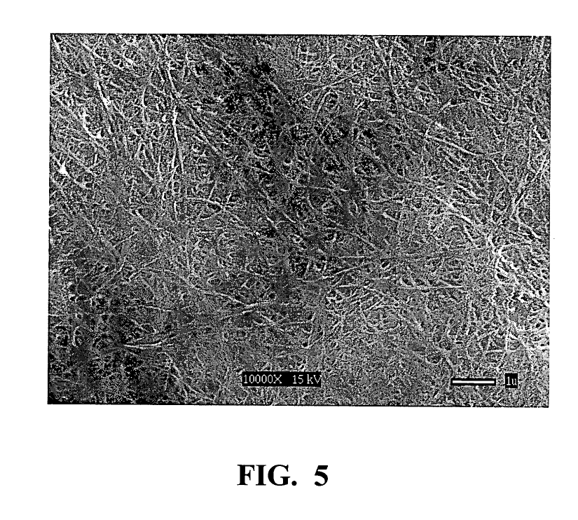

FIG. 5 illustrates the SEM micrograph of Example 4 at 10000× magnification showing the nanoweb on the porous support.

Examples 1 and 2 were characterized by capillary flow porometry, with samples of bonded, untreated TYVEK® used as controls. A Capillary Flow Porometer (PMI Capillary Porometer, Model CFP 34RTF8A-3-6-L4) was used for the tests. Air of a controlled pressure was applied to the top of a sample, which was secured in a holder, and the flow of air was measured on the bottom side of the sample. Then, a wetting fluid of known surface tension (1,1,2,3,3,3-hexafluoropropene, or “Galwick” having a surface tension of 16 dyne/cm) was applied to the top of the sample such that the sample was completely wetted but that excess fluid did not pool on the sample surface. The wetted sample was again exposed to the pressurized air. The wetting fluid was forced from the pores in a defined manner based on the pore properties as observed by the flow of air on the bottom side of the sample as the applied air pressure was increased. Multiple trials were performed for each type of sample. Data reduction was performed by the PMI instrument software to obtain the pore properties.

TABLE 2

| | | | Selected Pore Diameter Data, | | |
|---|---|---|---|---|---|
| | | | nm | | |
| Material | Drying | Bubble Point | | Mean | |
| Description | Treatment | Pressure, psi | Smallest | Flow | Largest |
| TYVEK ® | None | 0.8 | 234 | 1806 | 8753 |
| control | | | | | |
| TYVEK ® | VO | 0.8 | 254 | 1988 | 8770 |
| control | | | | | |
| Example 1 | VO | 21.5 | 149 | 373 | 515 |
| Example 2 | CPD | 54.6 | 106 | 107 | 129 |

The composite materials prepared as described in Example 4 were characterized by capillary flow porometry using a samples of the unmodified SUPOR® 800 as control using the methods described above. Results are set forth in Table 3.

TABLE 3

| | Drying | |
|---|---|---|
| Material Description | Treatment | Bubble Point Pressure, psi |
| SUPOR ® 800 control | None | 5.7 |
| SUPOR ® 800 control | VO | 5.4 |
| Example 4 | VO | 8.8 |

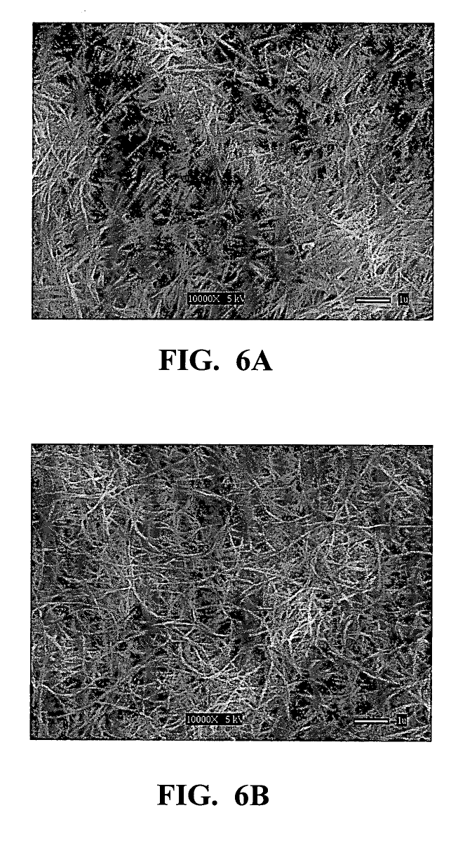

To demonstrate the stability of a composite material under applied air pressure, the composite material of Example 4 was loaded into the capillary flow porometry instrument and air pressure was applied to the top of the sample until a pressure of 10 psi was reached. The sample was removed and imaged by SEM to assess its stability. FIG. 6 illustrates the SEM micrograph at a magnification of 10000× showing the nanoweb fibers intact within the porous support as viewed from (a) the material surface exposed to the air pressure (top) and (b) the opposite material surface (bottom).

### EXAMPLE 9

This illustrates the preparation of a composite nanoweb material using the thixotropic, shear thinning organogelator (XLIII) in n-butanol, a nonwoven polyethylene porous support, and critical point drying (CPD) in carbon dioxide.

A slurry was prepared by mixing organogelator, XLIII (0.300 g), with n-butanol (10 g). The slurry was heated to 80° C. at which a homogeneous solution was observed. The solution was allowed to cool for 1 h to provide a gel. The gel was fluidized using a vortex at a setting of 10 for 1 min. A bonded TYVEK® fabric (0.0105 g) was immersed into the fluidized gel, the system sealed and allowed to sit in an ambient environment for 6 h after which the fluidized gel had reformed into a gel. The material was then removed and dried identically to Example 1. The resulting composite material had a weight of 0.0111 g.

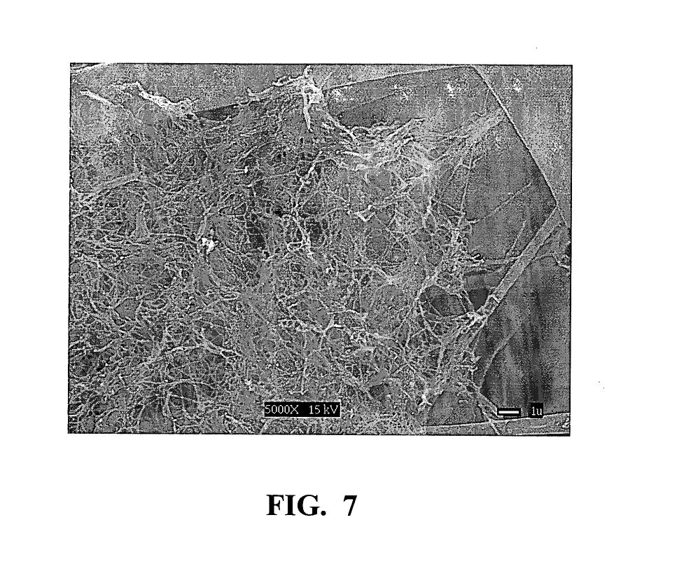

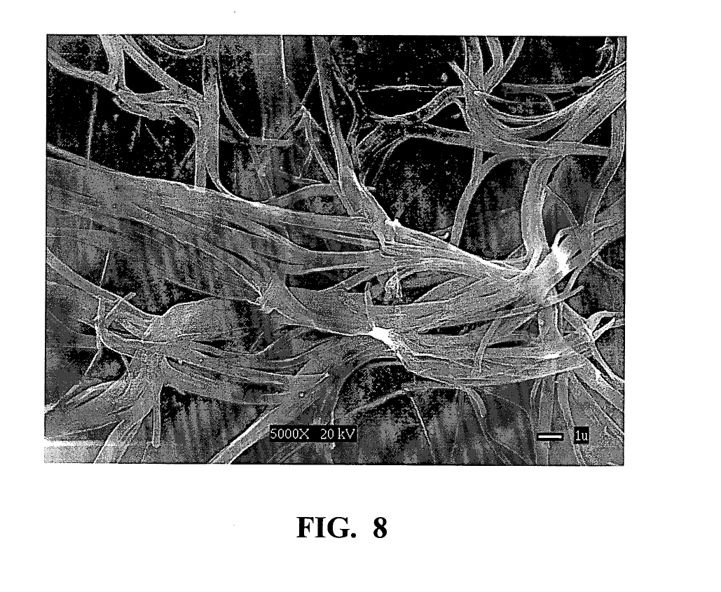

FIG. 7 illustrates the SEM micrograph at 5000× magnification showing the nanoweb fibers of (XLIII) on the porous support.

### EXAMPLES 10-17

In the following Examples (Table 4), unless otherwise indicated, a composite nanoweb material sample was formed by adding 2 wt % of the indicated organogelator to the indicated solvent in a reaction vial to form a slurry, immersing a small sample of the indicated support fabric into the slurry, heating the immersed sample to a temperature between about 80-110° C., stirring for a time sufficient to form a homogeneous solution and cooling to form a gel. The composite material so formed was removed from the reaction vial, and where necessary, excess gel was removed from the sample composite material with tweezers.

Drying and nanoweb formation was conducted using one of two methods: critical point drying (CPD) or vacuum oven drying (VO).

TABLE 4

| | Organogelator | | | Drying | |
|---|---|---|---|---|---|
| Ex. | Formula # | Solvent | Support | Technique | Figure # |
| 10 | XLVI | n-butanol | Tyvek ® | VO | |
| 11 | XLVI | n-butanol | Sontara ® | VO | |
| 12 | XXIX | cyclohexane | Tyvek ® | VO | |
| 13 | XXII | toluene | Tyvek ® | VO | |
| 14 | LII | 1,2- | Tyvek ® | VO | 8 |
| | | dichloroethane | | | |
| 15 | V | n-butanol | Suprel ® | CPD | |
| 16 | V | n-butanol | PA-66 | CPD | |
| | | | nanofiber | | |
| | | | web | | |
| 17 | V | n-butanol | PA-66 | VO | |
| | | | nanofiber | | |
| | | | web | | |

### EXAMPLES 18-21

Several samples were prepared in the manners essentially set forth in Examples 1 or 2, and evaluated for BET SSA. The results are set forth in Table 5 below.

TABLE 5

| | | | | | BET/ |
|---|---|---|---|---|---|
| | Organogelator | | | Drying | SSA |
| Ex. | Formula # | Solvent | Support | Technique | m²/g |
| Control 1 | none | none | Tyvek ® | none | 1.2 |
| 18 | V | n-butanol | Tyvek ® | VO | 3.3 |
| 19 | V | n-butanol | Tyvek ® | CPD | 4.2 |
| Control 2 | None | None | Sontara ® | none | 0.2 |
| 20 | V | n-butanol | Sontara ® | VO | 2.5 |
| 21 | V | n-butanol | Sontara ® | CPD | 24.3 |

As demonstrated by the data in Table 5, the BET/SSA of the treated samples according to the invention is drastically increased over the untreated control samples.

### EXAMPLES 22-29

The following samples were prepared essentially as set forth in Examples 1 and 2, and indicated below in Table 6, and evaluated for surface effects due to the deposited nanofiber web, particularly as to the advancing and receding contact angles of liquid droplets, to indicate the hydrophobicity or oleophobicity of the samples.

Contact Angle Measurements

Contact angle (CA) measurements to determine the contact angle of both water and hexadecane on a fabric or non-woven surface were performed using a goniometer. Ramé-Hart Standard Automated Goniometer Model 200 employing DROPimage standard software and equipped with an automated dispensing system with 250 μl syringe was used, having an illuminated specimen stage assembly. The non-woven samples were glued to a glass slide using double-sided tape. The goniometer, which is connected through an interface to a computer with computer screen, had an integral eye piece connected to a camera having both horizontal axis line indicator and an adjustable rotating cross line and angle scale, both independently adjustable by separate verniers. The syringes used were carefully cleaned with alcohol and allowed to dry completely before use.

Prior to contact angle measurement, the non-woven sample on the glass slide is clamped into place and the vertical vernier adjusted to align the horizontal line (axis) of the eye piece coincident to the horizontal plane of the non-wovens swatch, and the horizontal position of the stage relative to the eye piece positioned so as to view one side of the test fluid droplet interface region at the swatch interface.

To determine the contact angle of the test fluid on the non-woven swatch, approximately one drop of test fluid is dispensed onto the swatch using a small syringe fitted with a stainless steel needle and a micrometer drive screw to displace a calibrated amount of the test fluid. For water measurements, purified water, for example deionized or distilled water, is employed, and for oil measurements, hexadecane is suitably employed.

Horizontal and cross lines are adjusted via the software in case of the Model 200 after leveling the sample via stage adjustment, and the computer will calculate the contact angle based upon modeling the drop appearance. Alternatively, immediately upon dispensing the test fluid, the rotatable vernier is adjusted to align the cross line and cross position, that is the intersection of the rotatable cross line and the fixed horizontal line, coincident with the edge of the test fluid droplet and the swatch, and the cross line angle (rotation) then positioned coincident with the tangent to the edge of the test droplet surface, as imaged by the eye piece. The contact angle is then read from the angle scale, which is equivalent to the tangent angle.

The initial contact angle is that angle determined immediately after dispensing the test fluid to the swatch surface. Initial contact angles above 30 degrees are indicators of effective water and oil repellency. Contact angle can be measured after the droplet has been added to a surface (advancing contact angle, abbreviated “Adv. CA”) or after the droplet has been partially withdrawn from a surface (receding contact angle, abbreviated “Rec. CA”).

TABLE 6

| | | | | Adv. | | | |
|---|---|---|---|---|---|---|---|
| | Gelator | Drying | | CA | Rec. CA | Adv. CA | Rec. CA |
| Ex. | Formula # | Method | Substrate | (water) | (water) | (hexadecane) | (hexadecane) |
| 22 | V | CPD | Tyvek ® | 157 | 130 | Soaked in | Soaked in |
| 23 | V | VO | Tyvek ® | 130 | 0 | Soaked in | Soaked in |
| Untreated | | | Tyvek ® | 126 | | | |
| control | | | | | | | |
| 24** | V | CPD | Supor ® | 138 (static angle) | | Soaked in | |
| 25 | V | VO | Supor ® | 139 | 0 | Soaked in | Soaked in |
| Untreated | | | Supor ® | 0 | | | |
| control | | | | | | | |
| 26*** | V | CPD | Tyvek ® | 161 | 133 | Soaked in | Soaked in |
| 27*** | V | VO | Tyvek ® | 134 | 0 | Soaked in | Soaked in |
| 28 | V | CPD | Sontara ® | 165 | 138 | Soaked in | Soaked in |
| Untreated | | | Sontara ® | 143 | | | |
| control | | | | | | | |

| | | | | | |
|---|---|---|---|---|---|
| 29** | XLVI | VO | Supor ® | 153 (static angle) | 130 (static angle) |

**Dynamic CA could not be determined for these samples due to complete beading of the droplets, indicating the highly hydrophobic and/or oleophobic nature of these surfaces. Static CA were determined instead.
***Excess organogelator was scraped from the surface of these samples prior to drying.

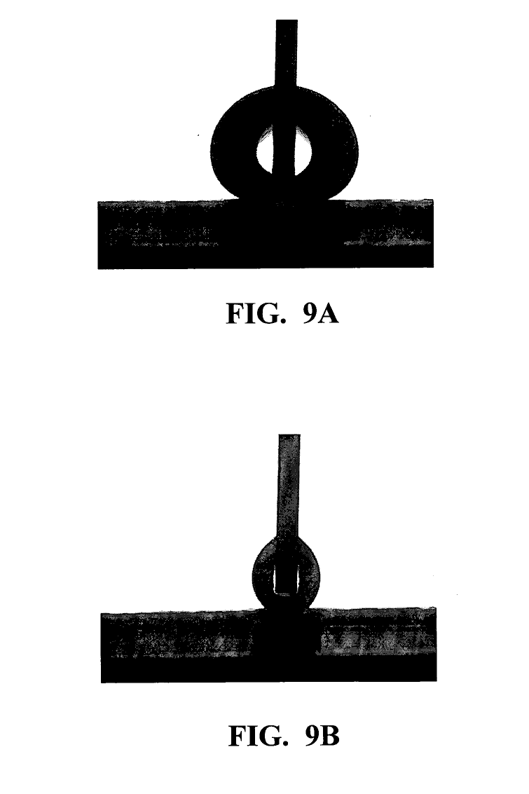

The advancing and receding water contact angles for Example 22 are shown in FIG. 9 (a) and (b), respectively. Several samples exhibited super-hydrophobicity as demonstrated by the data.

### EXAMPLES 30-33

In the following Examples (Table 7), unless otherwise indicated, a composite nanoweb material sample was formed by adding 2 wt % of the indicated organogelator to the indicated solvent in a reaction vial to form a slurry, heating the slurry to a temperature between about 80-110° C., stirring for a time sufficient to form a homogeneous solution, applying the hot solution as a coating of a thickness of a few millimeters to a sample of the indicated support one to several centimeters in dimension, covering the coated layer and allowing it to cool to form a gel, scraping excess gel coating from the support, and drying the composite materials using either the CPD or VO methods described for Table 1 examples.

TABLE 7

| | Gelator | | | | | | |
|---|---|---|---|---|---|---|---|
| | Formula | Drying | | | IPA | Oil | BET/SSA |
| Ex. | # | Method | Substrate | Solvent | Repellency | Repellency | m²/g |
| 30 | XLVI | VO | cellulose/ | n-butanol | 10 | 6 | — |
| | | | Sontara ® | | | | |
| 31 | XLVI | VO | PP SMS | n-butanol | — | 6 | — |
| 32 | V | CPD | Supor ® | n-butanol | — | — | — |
| 33 | V | CPD | Tyvek ® | n-butanol | — | — | 24.6 |

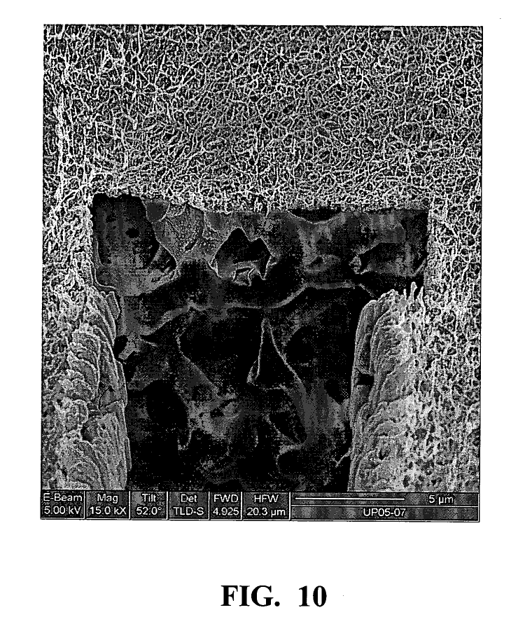

FIG. 10 illustrates the DB SEM micrograph of Example 32 at magnification 15,000× showing the nanoweb on the porous support.

What we claim is:

1. A method for making a composite material comprising a porous support and a porous nanoweb comprising:
a) providing a porous support;
b) providing a gelling mixture comprising one or more solvents and one or more organogelator(s);
c) applying the gelling mixture to the porous support;
d) inducing said organogelator(s) to form a nanoweb gel; and
e) removing the solvent(s) from the nanoweb gel to provide a dry porous nanoweb coating on said porous support.

2. The method of claim 1, wherein inducing the formation of a nanoweb gel comprises one or more steps selected from: cooling, heating, abating shearing, adding a non-solvent, and removing a solubilizing agent.

3. The method of claim 1, wherein removing the solvent from the nanoweb gel comprises at least one step selected from: freeze drying, ambient drying, vacuum drying, critical point drying, fluid-fluid extraction and supercritical fluid extraction.

4. The method of claim 1, wherein removing the solvent from the nanoweb gel comprises solvent exchange followed by critical point drying.

5. The method of claim 1 wherein said organogelator(s) are characterized by a molecular weight of about 200 to about 5000 g/mol.

6. The method of claim 1 wherein said organogelator(s) form a H-bonded nanoweb gel.

7. The method of claim 1 wherein said organogelator(s) form a π-stacked nanoweb gel.

8. The method of claim 1, wherein said porous support is a woven fabric, a nonwoven fabric, a porous polymer film, a porous inorganic material, wood, a wood laminate or combinations thereof.

9. The method of claim 8, wherein said porous support is a woven fabric comprising fibers of glass, polyamides, polyesters or combinations thereof.

10. The method of claim 8, wherein said porous support is a nonwoven fabric comprising fibers of glass, paper, cellulose acetate and nitrate, polyamides, polyesters, polyolefins or combinations thereof.

11. The method of claim 1, wherein said gelling mixture is a homogeneous isotropic solution.

12. The method of claim 1, wherein said gelling mixture is gel in the form of a film, sheet or powder that can be melted to form a fluidized gel.

13. The method of claim 1, wherein said gelling mixture is a gel that is shear-thinned prior to or during applying to the porous support and said gelling comprises abating said shearing in the impregnated support.

14. The method of claim 1, wherein removing the solvent from the nanoweb gel comprises solvent exchange followed by critical point drying and said solvent is exchanged with supercritical fluid CO₂.

15. The method of claim 1, wherein said c) applying the gelling mixture comprises coating and impregnating the porous support with the gelling mixture.

16. The method of claim 15, wherein said d) inducing formation of a nanoweb gel comprises cooling the impregnated support.

17. The method of claim 1 additionally comprising the independently optional steps of:
f) annealing the dried nanoweb; and
g) washing the dried nanoweb with a non-solvent.

18. The method of claim 1, wherein said organogelator(s) are selected from the group consisting of materials of formulae (I), (IIA), (IIB), (IIC) and (IID) including isomers or mixtures of isomers thereof: 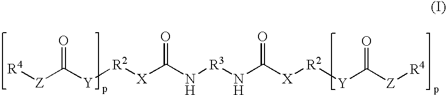
wherein
p is 0, 1, 2, or 3;
wherein
R³ is a divalent C3 to C18 linear or branched alkylene group, optionally, interrupted by one or two —OC(O)— groups; C1 to C6 linear or branched alkylene group bearing a C5-C16 cycloaliphatic group; C5-C16 cycloaliphatic or alkyl substituted cycloaliphatic group; C6 to C16 aromatic or alkyl substituted aromatic group; or C1 to C6 alkyl bearing an C6 to C16 aromatic or alkyl substituted aromatic group, optionally substituted on the aromatic group with Cl, Br, I, F, CF₃, CF₃O; a —(CH₂CH₂O)ₘ—CH₂CH₂— group with m being 1 to 4; and
R⁴ independently is a monovalent C2 to C16 linear or branched alkyl group; C5 to C12 cycloaliphatic group; C6 to C16 cycloaliphatic group bearing a linear or branched C1 to C8 alkyl group; C6 to C16 aromatic or alkyl substituted aromatic group; C1 to C6 alkyl bearing an C6 to C16 aromatic or alkyl substituted aromatic group; or
a —(CH₂CH₂O)ₙ—CH₃ group with n being independently 1 to 8; all aromatic groups optionally substituted with Cl, Br, I, F, CF₃, CF₃O and all alkyl and cycloaliphatic groups optionally substituted with one or two carbon-carbon double bonds;
wherein
if p is 0, R² is a monovalent C1 to C16 linear or branched alkyl group, a C1 to C6 linear or branched alkyl group bearing a C5-C16 cycloaliphatic group, a C5-C16 cycloaliphatic or alkyl substituted cycloaliphatic group, a C6 to C16 aromatic or alkyl substituted aromatic group, a C1 to C6 alkyl bearing an C6 to C16 aromatic or alkyl substituted aromatic group, all optionally substituted on the aromatic group with one or two Cl, Br, I, F, CF₃, and CF₃O; all alkyl and cycloaliphatic groups optionally substituted with one or two carbon-carbon double bonds; all aliphatic and cycloaliphatic groups optionally substituted with —OH, —OR⁶, —Si(OR⁶)₃, or —C(O)OR⁶; wherein R⁶ is C1 to C16 linear or branched alkyl group; or C6 to C16 aromatic group; and X is NH, O, or nothing;
wherein
if p is 1, R² is a divalent C1 to C8 linear or branched alkyl, a C1 to C6 alkyl bearing an C6 to C10 aromatic or alkyl substituted aromatic group, a —(CH₂CH₂O)ₙ—CH₂CH₂— group with n being 1 to 4,
wherein
if p is 2, R² is Formula (IIIa) and if p is 3, R² is Formula (IIIb) 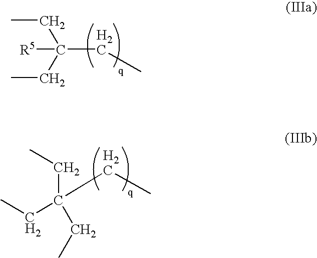
wherein
q is 0 or 1; and R⁵ is H, a C1 to C5 linear alkyl group;
wherein
if p is 1, 2, or 3, X is chosen from O or NH, Y is chosen from O, NH, or nothing, with the proviso that if X is O, Y cannot be O, and if X is NH, Y cannot be NH, Z is chosen from O, NH, or nothing; formula (IIA) 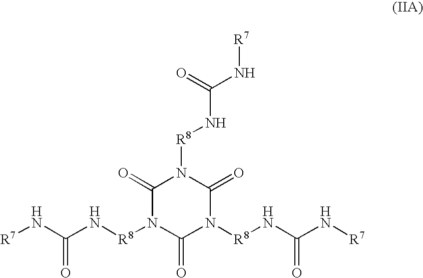
wherein
R⁷ is a monovalent C1 to C16 linear or branched alkyl group; C1 to C6 linear or branched alkyl group bearing a C5-C16 cycloaliphatic group; C5-C16 cycloaliphatic or alkyl substituted cycloaliphatic group; C6 to C16 aromatic or alkyl substituted aromatic group; or C1 to C6 alkyl bearing an C6 to C16 aromatic or alkyl substituted aromatic group; optionally substituted on the aromatic group with one or two Cl, Br, I, F, CF₃, and CF₃O; all aliphatic and cycloaliphatic groups optionally substituted with one or two carbon-carbon double bonds, all aliphatic and cycloaliphatic groups optionally interrupted by one or two —OC(O)— groups, all aliphatic and cycloaliphatic groups optionally substituted with —OH, —OR⁶, —Si(OR⁶)₃;
wherein
R⁶ is C1 to C16 linear or branched alkyl group; or C6 to C16 aromatic group; and
R⁸ is a divalent C3 to C8 linear or branched alkylene group; C1 to C6 linear or branched alkylene group bearing one or two C5-C8 cycloaliphatic groups; C5-C16 cycloaliphatic or alkyl substituted cycloaliphatic group; C6 to C16 aromatic or alkyl substituted aromatic group; or C1 to C6 alkyl bearing an C6 to C16 aromatic or alkyl substituted aromatic group; formula (IIB) 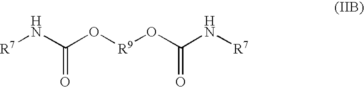
wherein
R⁹ is a divalent C2 to C18 linear or branched alkylene group; C1 to C6 linear or branched alkylene group bearing a C5-C16 cycloaliphatic group; C5-C16 cycloaliphatic or alkyl substituted cycloaliphatic group; or a —(CH₂CH₂O)ₘ—CH₂CH₂— group with m being 1 to 4, and R⁷ is as defined above; formula (IIC) 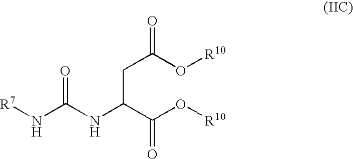
wherein
R⁷ is as defined above and R¹⁰ is —(CH₂)ᵤ—(CF₂)ᵥ—CF₃, with u equal to 1 to 4, and v equal to 0 to 9; and formula (IID) 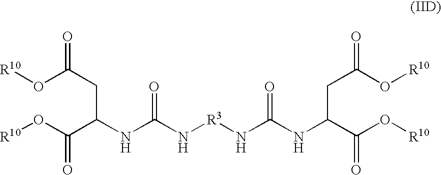
wherein
R³ is as defined above and R¹⁰ is as defined above.

19. A composite material comprising a porous support and a porous nanoweb, wherein said porous nanoweb comprises fibrous structures of between about 10 nm and about 1000 nm effective average fiber diameter as determined with electron microscopy; said fibrous structures being comprised of one or more non-covalently-bonded organogelators.

20. The composite material of claim 19, wherein said organogelator is selected from the group: H-bonded organogelators and π-stacked organogelators.

21. The composite material of claim 19, wherein said fibrous structures comprise H-bonded organogelators comprising four or more N—H-bonds per molecule.

22. The composite material of claim 19, wherein said fibrous structures comprise H-bonded organogelators comprising two or more groups per molecule selected from the group of: urea, ureido-pyrimidone, amide, and urethane.

23. The composite material of claim 19, wherein said fibrous structures comprise H-bonded organogelators comprising one or more compounds selected from the group consisting of materials of formulae (I), (IIA), (IIB), (IIC) and (IID) including isomers or mixtures of isomers thereof: 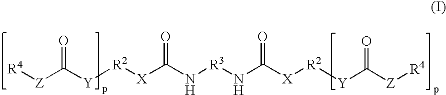
wherein
p is 0, 1, 2, or 3;
wherein
R³ is a divalent C3 to C18 linear or branched alkylene group, optionally, interrupted by one or two —OC(O)— groups; C1 to C6 linear or branched alkylene group bearing a C5-C16 cycloaliphatic group; C5-C16 cycloaliphatic or alkyl substituted cycloaliphatic group; C6 to C16 aromatic or alkyl substituted aromatic group; or C1 to C6 alkyl bearing an C6 to C16 aromatic or alkyl substituted aromatic group, optionally substituted on the aromatic group with Cl, Br, I, F, CF₃, CF₃O; a —(CH₂CH₂O)ₘ—CH₂CH₂— group with m being 1 to 4; and
R⁴ independently is a monovalent C2 to C16 linear or branched alkyl group; C5 to C12 cycloaliphatic group; C6 to C16 cycloaliphatic group bearing a linear or branched C1 to C8 alkyl group; C6 to C16 aromatic or alkyl substituted aromatic group; C1 to C6 alkyl bearing an C6 to C16 aromatic or alkyl substituted aromatic group; or
a —(CH₂CH₂O)ₙ—CH₃ group with n being independently 1 to 8; all aromatic groups optionally substituted with Cl, Br, I, F, CF₃, CF₃O and all alkyl and cycloaliphatic groups optionally substituted with one or two carbon-carbon double bonds;
wherein
if p is 0, R² is a monovalent C1 to C16 linear or branched alkyl group, a C1 to C6 linear or branched alkyl group bearing a C5-C16 cycloaliphatic group, a C5-C16 cycloaliphatic or alkyl substituted cycloaliphatic group, a C6 to C16 aromatic or alkyl substituted aromatic group, a C1 to C6 alkyl bearing an C6 to C16 aromatic or alkyl substituted aromatic group, all optionally substituted on the aromatic group with one or two Cl, Br, I, F, CF₃, and CF₃O; all alkyl and cycloaliphatic groups optionally substituted with one or two carbon-carbon double bonds; all aliphatic and cycloaliphatic groups optionally substituted with —OH, —OR⁶, —Si(OR⁶)₃, or —C(O)OR⁶; wherein R⁶ is C1 to C16 linear or branched alkyl group; or C6 to C16 aromatic group; and X is NH, O, or nothing;
wherein
if p is 1, R² is a divalent C1 to C8 linear or branched alkyl, a C1 to C6 alkyl bearing an C6 to C10 aromatic or alkyl substituted aromatic group, a —(CH₂CH₂O)ₙ—CH₂CH₂— group with n being 1 to 4,
wherein
if p is 2, R² is Formula (IIIa) and if p is 3, R² is Formula (IIIb) 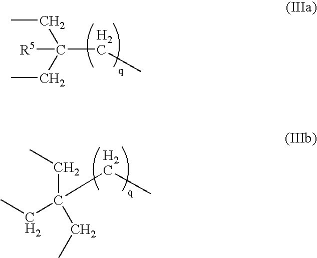
wherein
q is 0 or 1; and R⁵ is H, a C1 to C5 linear alkyl group;
wherein
if p is 1, 2, or 3, X is chosen from O or NH, Y is chosen from O, NH, or nothing, with the proviso that if X is O, Y cannot be O, and if X is NH, Y cannot be NH, Z is chosen from O, NH, or nothing; formula (IIA) 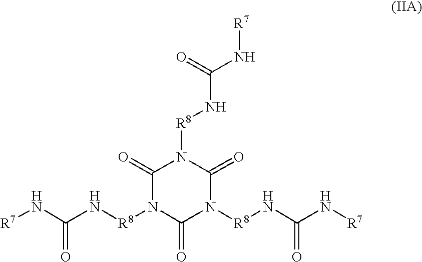
wherein
R⁷ is a monovalent C1 to C16 linear or branched alkyl group; C1 to C6 linear or branched alkyl group bearing a C5-C16 cycloaliphatic group; C5-C16 cycloaliphatic or alkyl substituted cycloaliphatic group; C6 to C16 aromatic or alkyl substituted aromatic group; or C1 to C6 alkyl bearing an C6 to C16 aromatic or alkyl substituted aromatic group; optionally substituted on the aromatic group with one or two Cl, Br, I, F, CF₃, and CF₃O; all aliphatic and cycloaliphatic groups optionally substituted with one or two carbon-carbon double bonds, all aliphatic and cycloaliphatic groups optionally interrupted by one or two —OC(O)— groups, all aliphatic and cycloaliphatic groups optionally substituted with —OH, —OR⁶, —Si(OR⁶)₃;
wherein
R⁶ is C1 to C16 linear or branched alkyl group; or C6 to C16 aromatic group; and
R⁸ is a divalent C3 to C8 linear or branched alkylene group; C1 to C6 linear or branched alkylene group bearing one or two C5-C8 cycloaliphatic groups; C5-C16 cycloaliphatic or alkyl substituted cycloaliphatic group; C6 to C16 aromatic or alkyl substituted aromatic group; or C1 to C6 alkyl bearing an C6 to C16 aromatic or alkyl substituted aromatic group; formula (IIB) 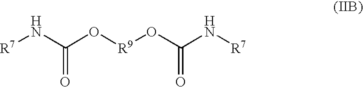
wherein
R⁹ is a divalent C2 to C18 linear or branched alkylene group; C1 to C6 linear or branched alkylene group bearing a C5-C16 cycloaliphatic group; C5-C16 cycloaliphatic or alkyl substituted cycloaliphatic group; or a —(CH₂CH₂O)ₘ—CH₂CH₂— group with m being 1 to 4, and R⁷ is as defined above; formula (IIC) 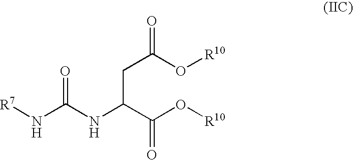
wherein
R⁷ is as defined above and R¹⁰ is —(CH₂)ᵤ—(CF₂)ᵥ—CF₃, with u equal to 1 to 4, and v equal to 0 to 9; and formula (IID) 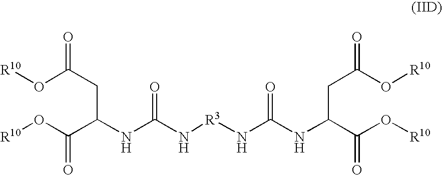
wherein
R³ is as defined above and R¹⁰ is as defined above.

24. The composite material of claim 23 wherein said H-bonded organogelators comprise one or more compounds selected from the formulae:

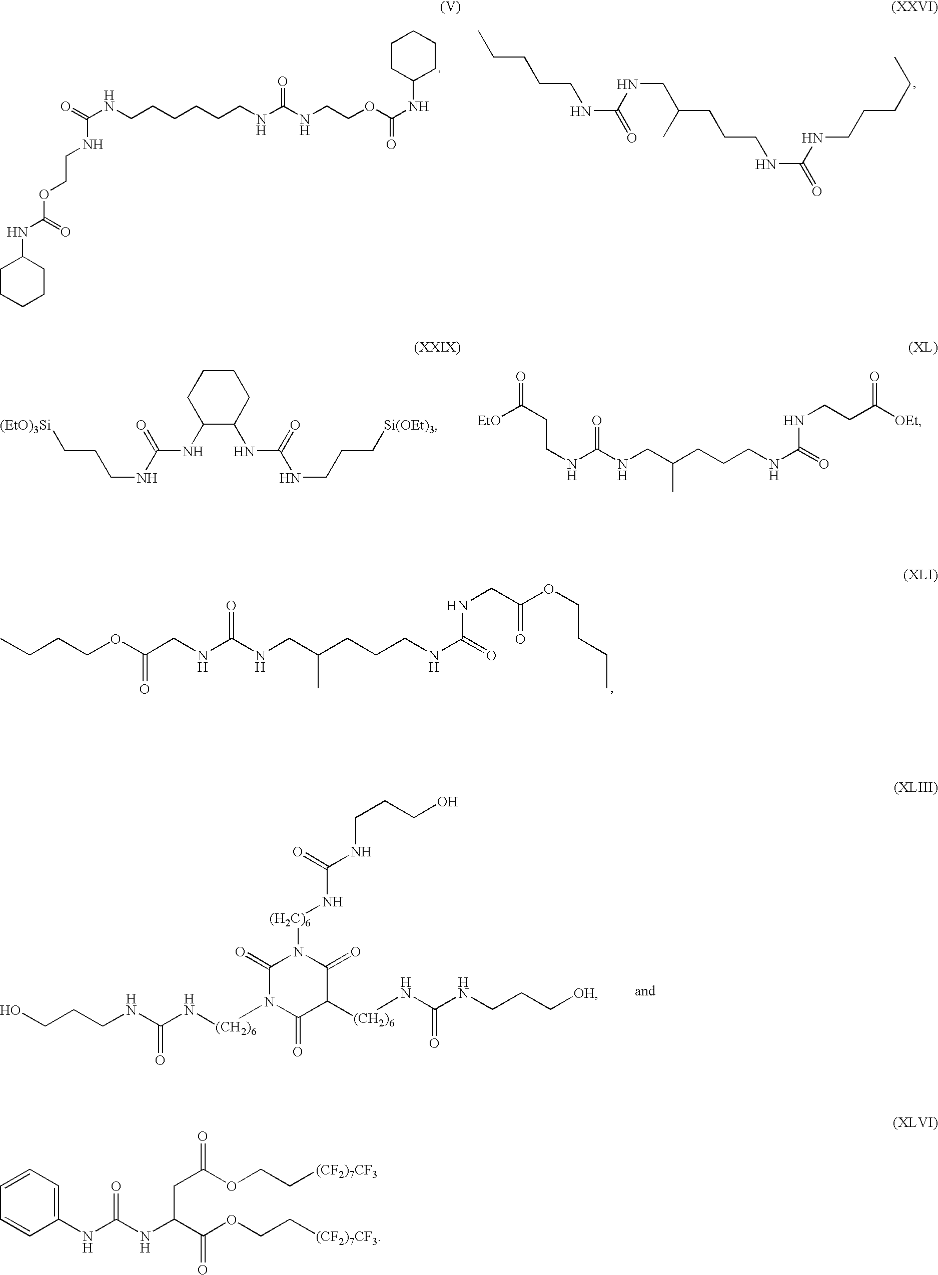

25. The composite material of claim 19, wherein said fibrous structure comprises π-stacked organogelator of formula (LII)

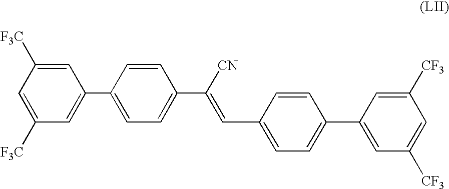

26. The composite material of claim 19, wherein said porous support is a woven fabric, a nonwoven fabric, a porous polymer film, a porous inorganic material, wood, a wood laminate, or combinations thereof.

27. The composite material of claim 26, wherein said porous support is a woven fabric comprising fibers of glass, polyamides, polyesters or combinations thereof.

28. The composite material of claim 26, wherein said porous support is a nonwoven fabric comprising fibers of glass, paper, cellulose acetate and nitrate, polyamides, polyesters, polyolefins or combinations thereof.

29. The composite material of claim 26, wherein said porous support is a nonwoven fabric comprising bonded fibers of polyethylene, polypropylene, polyester, or combinations thereof.

30. The composite material of claim 19, wherein said porous support is a porous polymer film comprising polyethersulfone, polyamide, polypropylene, polytetrafluoroethylene, and cellulose esters.

31. The composite material of claim 19, wherein said porous support is comprised of a layer of polymeric nanofibers, with an effective fiber diameter in the range of about 20 nm to about 1 μm.

32. The composite material of claim 31, wherein the layer of nanofibers is self-supporting.

33. The composite material of claim 31, wherein the layer of nanofibers is further supported by one or more other porous supports.

34. The composite material of claim 19, wherein said porous support comprises multi-layer nonwoven laminates comprising spunbond and meltblown layers.

35. A filter for gaseous fluids comprising the composite material of claim 19.

36. A filter for liquid fluids comprising the composite material of claim 19.

37. A conformable cleaning wipe comprising the composite material of claim 19.

38. A barrier fabric comprising the composite material of claim 19.

39. The composite material of claim 19, wherein said porous nanoweb coats the individual fibers of the fibrous structure.

40. The composite material of claim 19, wherein the porous nanoweb interpenetrates said porous support.

41. The composite material of claim 19, wherein the porous nanoweb interpenetrates and coats said porous support.

42. The composite material of claim 19, wherein the porous nanoweb is a coating on said porous support.
